(19) United States
(12) Patent Application Publication
(10) Pub. No.: US 2014/0146435 A1
(43) Pub. Date: May 29, 2014

(54) IN-PLANE MEMS VARACTOR

(71) Applicant: QUALCOMM MEMS TECHNOLOGIES, INC., San Diego, CA (US)

(72) Inventors: Philip Jason Stephanou, Mountain View, CA (US); Ming-Hau Tung, San Francisco, CA (US); Ravindra V. Shenoy, Dublin, CA (US)

(73) Assignee: QUALCOMM MEMS TECHNOLOGIES, INC., San Diego, CA (US)

(21) Appl. No.: 13/686,524

(22) Filed: Nov. 27, 2012

(51) Int. Cl. H01G 5/18; H01G 5/40

(52) U.S. Cl. CPC H01G 5/18; H01G 5/40
USPC 361/290

(57) ABSTRACT

This disclosure provides systems, methods and apparatus for providing an in-plane electromechanical systems (EMS) varactor. In one aspect, the in-plane EMS varactor may include in-plane relative translation between a second portion and a first portion. Such translation may cause a change in a gap or overlap between first electrodes that remain fixed with respect to the first portion and second electrodes that remain fixed with respect to the second portion that may cause a change in capacitance between the first and second electrodes. In some implementations, the configuration of the second portion and the first portion may be either of two mechanically bi-stable states.

### TECHNICAL FIELD

This disclosure relates to variable capacitors and to techniques and devices that may be used with microelectromechanical, nanoelectromechanical, or other electromechanical systems.

### DESCRIPTION OF THE RELATED TECHNOLOGY

Electromechanical systems (EMS) include devices having electrical and mechanical elements, transducers such as sensors and actuators, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about one micron to hundreds of microns or more. Nanoelectromechanical systems (NEMS) devices can include structures having sizes smaller than one micron including, for example, sizes smaller than several hundred nanometers. Electromechanical elements may be created using deposition, etching, lithography, and/or other micromachining processes that remove parts of substrates and/or deposited material layers, or that add layers to form electrical and electromechanical devices.

One type of device that may be implemented as an EMS is a variable capacitor, also commonly referred to as a varactor. A varactor may be configured to supply different capacitances to an electrical circuit depending on how elements of the varactor are positioned.

### SUMMARY

The systems, methods and devices of this disclosure each have several innovative aspects, no single one of which is solely responsible for the desirable attributes disclosed herein.

One innovative aspect of the subject matter described in this disclosure can be implemented in a varactor. The varactor may be provided on, for example, a substrate, and may include a first portion in a plane substantially parallel to the substrate and a second portion substantially co-planar with the first portion. The varactor also may include one or more first electrodes substantially fixed with respect to the first portion and one or more second electrodes substantially fixed with respect to the second portion. A first beam may be joined to the second portion at a first end of the first beam and joined to the first portion at a second end of the first beam opposite the first end of the first beam. The first beam may be substantially co-planar with the second portion and the first portion. Similarly, a second beam may be joined to the second portion at a first end of the second beam and joined to the first portion at a second end of the second beam opposite the first end of the second beam. The second beam may be substantially co-planar with the second portion and the first portion.

In some implementations, the varactor also may include a drive mechanism. In such implementations, the first beam and the second beam may be elastic elements that are free to deform substantially by bending in a plane parallel to the substrate. The first beam and the second beam also may be configured to constrain relative motion between the second portion and first portion to a single translational degree of freedom substantially along a translation axis parallel to the substrate. The one or more first electrodes may be configured to undergo substantially the same translational motion as the first portion, and the one or more second electrodes may be configured to undergo substantially the same translational motion as the second portion. The varactor may be further configured such that relative linear translation of the first portion with respect to the second portion results in a change in capacitance associated with the one or more first electrodes and the one or more second electrodes, and such that the drive mechanism causes relative linear translation between the first portion and the second portion.

In some implementations of the varactor, the drive mechanism may be a capacitive drive mechanism that is conductively isolated from the one or more first electrodes and the one or more second electrodes. In some such implementations of the varactor, the capacitive drive mechanism may be selected from the group consisting of a closing-gap capacitive drive mechanism and a changing-overlap capacitive drive mechanism. In some further such implementations of the varactor, the capacitive drive mechanism may include one or more third electrodes and one or more fourth electrodes, the one or more third electrodes substantially fixed with respect to the first portion and the one or more fourth electrodes substantially fixed with respect to the second portion. The one or more first electrodes and the one or more second electrodes may be separated by a first gap and may overlap each other in a first overlap area. The one or more third electrodes and the one or more fourth electrodes may be separated by a second gap and may overlap each other in a second overlap area. The first overlap area divided by the first gap may be substantially less than the second overlap area divided by the second gap.

In some implementations of the varactor, the varactor also may include a third beam that is joined to the second portion at a third end of the third beam and that is joined to the first portion at a fourth end of the third beam opposite the third end of the third beam. The third beam may be substantially co-planar with the second portion and the first portion. The varactor also may include a fourth beam that is joined to the second portion at a third end of the fourth beam and that is joined to the first portion at a fourth end of the fourth beam opposite the third end of the fourth beam, the fourth beam substantially co-planar with the second portion and the first portion. In such varactor implementations, the third beam and the fourth beam may be symmetric with respect to the first beam and the second beam, respectively, across a plane parallel to the translation axis and perpendicular to the substrate. Furthermore, the first beam may be offset from the third beam along the translation axis, and the second beam may be offset from the fourth beam along the translation axis. The second portion may have a series of openings through one or more sub-portions of the second portion, and the one or more fourth electrodes may be located on sides of the openings perpendicular to the translation axis. The first portion also may include a central post fixed with respect to the substrate.

In some such implementations of the varactor, the openings may be at least two series of elongated slots in opposing sub-portions of the second portion, each slot having a substantially rectangular cross-section in a reference plane parallel to the substrate with a long axis in a direction transverse to the translation axis. In some further such implementations of the varactor, the one or more third electrodes may be located on at least two series of electrode posts fixed with respect to the substrate, each elongated slot having at least one drive electrode post protruding into it. The one or more third electrodes may be located on sides of the one or more drive electrode posts perpendicular to the translation axis.

In some implementations, the one or more fourth electrodes may be located on one or more regions of a surface of the second portion facing the substrate and interposed between the openings, the one or more third electrodes may be located on the substrate and facing the one or more fourth electrodes, and the one or more third electrodes may be spaced apart along the translation axis by distances corresponding to the spacing of the openings along the translation axis. In some implementations, the drive mechanism may be a piezoelectric linear or bending actuator conductively isolated from the one or more first electrodes and the one or more second electrodes. In some implementations, the first beam and the second beam may be folded beam elements.

In some implementations of the varactor, a third beam may be joined to the second portion at a first end of the third beam and may be joined to the first portion at a second end of the third beam opposite the first end of the third beam. The third beam may be substantially co-planar with the second portion and the first portion. The varactor also may include a fourth beam joined to the second portion at a first end of the fourth beam and joined to the first portion at a second end of the fourth beam opposite the first end of the fourth beam. The fourth beam may be substantially co-planar with the second portion and the first portion. The first beam, the second beam, the third beam, and the fourth beam may all be curved beams, each with a shape that substantially corresponds with approximately half of the shape of the first buckling mode of a straight, prismatic beam. The third beam and the fourth beam also may be symmetric with respect to the first beam and the second beam, respectively, across a plane parallel to the translation axis and perpendicular to the substrate. The first beam may be offset from the third beam along the translation axis and the second beam may be offset from the fourth beam along the translation axis. The first beam may be substantially parallel to the third beam and the second beam may be substantially parallel to the fourth beam. The first portion and the second portion may be movable between a first configuration and a second configuration relative to each other. In the first configuration, the first beam and the third beam may be in an unstressed state, and in the second configuration, the first beam and the third beam may be in a stressed state. The first portion and the second portion also may be configured to remain in the first configuration or the second configuration absent the application of an external force.

In some such implementations of the varactor, the first configuration and the second configuration may represent elastically stable states of the varactor. In some such implementations, the varactor may have two discrete capacitance states, each associated with a different one of the first configuration and the second configuration.

In some implementations of the varactor, the one or more first electrodes may be separated from the one or more second electrodes by a gap distance along the linear translation axis that varies when the first portion and the second portion are linearly translated with respect to each other. In some such implementations of the varactor, the one or more first electrodes may include a first subgroup of first electrodes and a second subgroup of first electrodes, each subgroup isolated from the other with respect to electrical conductivity. Furthermore, each of the one or more second electrodes may be a floating shunt electrode that overlaps at least one of the first electrodes in the first subgroup of first electrodes and one of the first electrodes in the second subgroup of first electrodes during linear translation of the first portion with respect to the second portion along the linear translation axis.

In some implementations, the one or more first electrodes may be separated from the one or more second electrodes by a gap that remains substantially constant during linear translation of the first portion relative to the second portion, the gap in a direction substantially perpendicular to the plane. The one or more first electrodes may be configured to at least partially overlap the one or more second electrodes during at least some portion of linear translation of the first portion with respect to the second portion along the linear translation axis, and the extent of the overlap between the one or more first electrodes and the one or more second electrodes may vary when the first portion and the second portion are linearly translated with respect to each other.

In some such implementations, the one or more first electrodes may include a first subgroup of first electrodes and a second subgroup of first electrodes that may be isolated from one another with respect to electrical conductivity. Each of the one or more second electrodes may be a floating shunt electrode that at least partially overlaps at least one of the first electrodes in the first subgroup of first electrodes and one of the first electrodes in the second subgroup of first electrodes during at least some portion of linear translation of the first portion with respect to the second portion along the linear translation axis. The extent of the overlap between each of the one or more second electrodes and the at least one of the first electrodes in the first subgroup of first electrodes and the at least one of the first electrodes in the second subgroup of first electrodes may vary when the first portion and the second portion are linearly translated with respect to each other.

In some implementations, the first portion may be affixed to the substrate and the second portion may be movable with respect to the substrate. In some other implementations, the second portion may be affixed to the substrate and the first portion may be movable with respect to the substrate

In some further implementations, the varactor may be used in a circuit for an apparatus including an inductor. The varactor and the inductor may be electrically connected in parallel or in series with one another to form an LC circuit. In some such implementations of the apparatus, the LC circuit may be part of a radio-frequency (RF) component in a wireless mobile communications device. In some implementations of the apparatus, the LC circuit may be configured to be switchable between a first resonant frequency and a second resonant frequency by translating the first portion and the second portion of the varactor with respect to each other. In some implementations, the LC circuit may be part of at least one of a receiver, transceiver, and transmitter.

Another innovative aspect of the subject matter described in this disclosure can be implemented in a varactor that includes stationary electrodes, movable electrodes and flexure means. The flexure means can be implemented to join the stationary electrodes to the movable electrodes and to constrain motion of the movable electrodes with respect to the stationary electrodes. In some implementations, the motion is in-plane with the stationary electrodes. The varactor also can include drive mechanism means configured for moving the movable electrodes with respect to the stationary electrodes between two positions. The varactor may provide different capacitances in each position.

In some such implementations, the flexure means may have two elastically stable states, each associated with a different one of the two positions. In some implementations, the flexure means may include two pairs of curved beams, each with a shape that substantially corresponds with approximately half of the shape of the first buckling mode of a straight, prismatic beam. In some implementations, the stationary electrodes and the movable electrodes may be electrically isolated from the drive mechanism means with respect to electrical conductivity.

Another innovative aspect of the subject matter described in this disclosure can be implemented in a method of using a varactor. The method may include applying a first voltage across a first gap between one or more first electrodes and one or more second electrodes to provide a first capacitance and imparting translational motion of a second portion of the varactor with respect to a first portion of the varactor along a translation axis. The translation axis may be substantially parallel to a substrate of the varactor, the second portion and the first portion may be substantially co-planar with each other, and the one or more first electrodes may be substantially fixed with respect to the first portion. The one or more second electrodes may be substantially fixed with respect to the second portion. The method may further include applying a voltage across the first gap to provide a second capacitance different from the first capacitance.

In some implementations of the method, the translational motion may be actuated by applying a voltage across a second gap between one or more third electrodes and one or more fourth electrodes to produce a first translation force. The first translation force may act on the second portion and the first portion. The one or more third electrodes and the one or more fourth electrodes may be isolated from the one or more first electrodes and the one or more second electrodes with respect to electrical conductivity.

Details of one or more implementations of the subject matter described in this disclosure are set forth in the accompanying drawings and the description below. Although the examples provided in this disclosure are primarily described in terms of EMS and MEMS-based devices the concepts provided herein may apply to other types of devices such as displays, e.g., liquid crystal displays (LCDs), organic light-emitting diode (OLED) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 depicts a plan view of an example of a two-beam in-plane MEMS varactor in a displaced configuration.

FIG. 2 depicts a plan view of an example of a four-beam in-plane MEMS device.

FIG. 3A depicts a plan view of an example of a straight prismatic beam structure with fixed-fixed ends.

FIG. 3B depicts a plan view of an example of a beam structure with a shape substantially corresponding to one half of the first buckling mode shape of a straight prismatic beam structure with fixed-fixed ends.

FIG. 3C depicts a plan view of an example of a folded beam structure with fixed-fixed ends.

FIG. 4 depicts a plan view of another example of a four-beam in-plane MEMS device.

FIG. 5A depicts a plan view of an example of a four-beam in-plane MEMS varactor that produces a variable circuit capacitance through a changing-overlap capacitance mechanism.

FIG. 5B depicts a plan view of the example of the four-beam in-plane MEMS varactor of FIG. 5A in a high-capacitance configuration.

FIG. 6A depicts a plan view of an example of a four-beam in-plane MEMS varactor that produces a variable circuit capacitance through a closing-gap capacitance mechanism.

FIG. 6B depicts a plan view of the example of the four-beam in-plane MEMS varactor of FIG. 6A in a high-capacitance configuration.

FIG. 7A depicts a cross-sectional view of an example of a conceptual in-plane varactor that produces a variable circuit capacitance through a closing-gap capacitance mechanism.

FIG. 7B depicts a cross-sectional view of the example of the conceptual in-plane varactor of FIG. 7A in a high-capacitance configuration.

FIG. 8A depicts a plan view of an example of an in-plane varactor that produces a variable circuit capacitance through a closing-gap capacitance mechanism featuring a movable shunt electrode.

FIG. 8B depicts the example of the in-plane varactor of FIG. 8A in a high-capacitance configuration.

FIG. 9A depicts a cross-sectional view of an example of a conceptual in-plane varactor that produces a variable circuit capacitance through a changing-overlap variable capacitance mechanism.

FIG. 9B depicts a cross-sectional view of the example of the conceptual in-plane varactor of FIG. 9A in a high-capacitance configuration.

FIG. 10A depicts a cross-sectional view of an example of an in-plane varactor that produces a variable circuit capacitance through a changing-overlap capacitive mechanism featuring movable shunt electrodes.

FIG. 10B depicts the example of the in-plane varactor of FIG. 10A in a low-capacitance configuration.

FIG. 11A depicts a cross-sectional view of an example of a conceptual in-plane varactor that uses a closing-gap capacitive actuation mechanism that may be used to produce translational motion in the conceptual in-plane varactor.

FIG. 11B depicts a cross-sectional view of the example of the conceptual in-plane varactor of FIG. 11A with the second portion of the in-plane varactor actuated to the left.

FIG. 11C depicts a cross-sectional view of the example of the conceptual in-plane varactor of FIG. 11A with the second portion of the in-plane varactor actuated to the right.

FIG. 12A depicts a cross-sectional view of an example of a conceptual changing-overlap capacitive actuation mechanism that may be used to produce translational motion in an in-plane varactor.

FIG. 12B depicts a cross-sectional view of the example of the conceptual changing-overlap capacitive actuation mechanism of FIG. 12A with the second portion of the in-plane varactor actuated to the right.

FIG. 12C depicts a cross-sectional view of the example of the conceptual changing-overlap capacitive actuation mechanism of FIG. 12A with the second portion of an in-plane varactor actuated to the left.

FIG. 13A depicts an isometric view of one example of an implementation of an in-plane MEMS varactor that uses a closing-gap capacitive mechanism with a shunt electrode to provide a variable circuit capacitance and a separate closing-gap capacitive actuation mechanism to impart translational motion.

FIG. 13B depicts an isometric exploded view of the example of the implementation of the in-plane MEMS varactor of FIG. 13A.

FIG. 13C depicts a plan view of the example of the implementation of the in-plane MEMS varactor of FIG. 13A.

FIG. 14A depicts an isometric view of an example of an implementation of an in-plane MEMS varactor that uses a closing-gap capacitive mechanism to provide a variable circuit capacitance and a separate changing-overlap capacitive actuation mechanism to impart translational motion.

FIG. 14B depicts an isometric exploded view of the example of the implementation of the in-plane MEMS varactor of FIG. 14A.

FIG. 14C depicts a plan view of the example of the implementation of the in-plane MEMS varactor of FIG. 14A.

FIG. 15 depicts a block diagram showing one example of a technique for using an in-plane MEMS varactor.

FIG. 16 depicts a block diagram showing a further example of a technique for using an in-plane MEMS varactor.

FIGS. 17A and 17B depict example schematic exploded partial perspective views of a portion of an electromechanical systems (EMS) package including an array of EMS elements and a backplate.

FIGS. 18A and 18B depict example system block diagrams illustrating a display device that includes a plurality of interferometric modulator (IMOD) display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways, including in ways not depicted in the Figures herein. The described implementations may be implemented in any number of devices, apparatuses, or systems that may benefit from a variable capacitance device. More particularly, it is contemplated that the described implementations may be included in or associated with a variety of electronic devices such as, but not limited to: mobile telephones, smartphones including multimedia internet enabled cellular telephones, and other wireless communication devices, television receivers, Bluetooth®, Zigbee® and other short-range communication-enabled devices, personal data assistants (PDAs), wireless electronic mail receivers, hand-held or portable computers in a variety of formats including, but not limited to, netbooks, notebooks, smartbooks, and tablets, printers, copiers, scanners, facsimile devices, global positioning system (GPS) receivers/navigators, digital cameras and camcorders, digital media players (such as MP3 players), game consoles, wrist watches, clocks, calculators, television monitors, flat panel displays, electronic reading devices (e.g., e-readers), computer monitors, automotive displays (including odometer and speedometer displays, etc.), augmented reality (AR) devices, cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in other applications such as, but not limited to, electronic switching devices, radio frequency filters, oscillators, accelerometers, gyroscopes, motion-sensing devices, magnetometers, and other sensors for consumer electronic devices, parts of consumer electronics products, liquid crystal devices, electrophoretic devices, drive schemes, manufacturing processes and electronic test equipment.

A MEMS varactor device is provided including a first portion and a second portion that is proximate, substantially parallel to a substrate, and joined together by two or more elastic beams. In some implementations, the first portion may be an inner portion and the second portion may be an outer portion. In some other implementations, the first portion may be an outer portion and the second portion may be an inner portion. Each beam may join the second portion of the varactor at a first end of the beam and the first portion of the varactor at a second, opposite end of the beam. The arrangement of the beams may be substantially symmetric about one or more planes perpendicular to the substrate. The second portion and the first portion may be substantially constrained by the beams to a single translational degree of freedom along a prescribed translation axis. The relative linear motion between the second portion and the first portion of the varactor may be substantially in a plane that is parallel to the substrate. An actuator may be included in the varactor to drive relative motion between the second portion and the first portion of the device.

The beams may be realized using a variety of topologies. In some implementations, simple or “folded” beams may be used to provide an elastic coupling between the second portion and the first portion that substantially constrains the second portion and the first portion to a single degree of freedom of relative linear motion. Such implementations may have only one elastically stable static equilibrium configuration and may require the sustained application of an external force to maintain any other static configuration. In some other implementations, four or more curved beams may be used to provide a varactor with two elastically stable static equilibrium configurations. For example, if the curvature of each curved beam corresponds substantially to the curvature of one-half of a fixed-fixed straight prismatic beam in its first buckling mode (as seen in a plan view of the varactor), then the mapping between the external force and the displacement of the second portion can follow a hysteresis loop characterized by two elastic equilibrium configurations that can be maintained in the absence of any external force. The stable configurations are separated by elastically unstable configurations that can be traversed through the application of an external force in an appropriate direction and of sufficient magnitude.

The varactor also may include one or more first electrodes and one or more second electrodes. The one or more first electrodes may be fixed with respect to the first portion, and the one or more second electrodes may be fixed with respect to the second portion. Thus, the one or more first electrodes and the one or more second electrodes may undergo the same relative motion as the first portion and second portion of the varactor. The first electrode(s) and the second electrode(s) may be configured to be separated by a gap and to at least partially overlap one another, thereby forming a capacitor. The first electrodes and the second electrodes may be located on the first portion and the second portion, respectively, such that the degree of gap or overlap between the first and second electrodes varies when the first portion and the second portion translate with respect to each other. The resulting gap or overlap variation may, in turn, cause a change in a capacitance that the varactor may present to an external electrical circuit. This capacitance may be termed a “circuit capacitance” for purposes of this disclosure.

For example, in some implementations, the second portion may be connected to the first portion by four beams. The first end of each beam may be joined to the second portion, and the second end of each beam may be joined to the first portion. In some implementations, the beams may have a shape corresponding to one half of the first buckling mode shape of a fixed-fixed prismatic beam. The resulting structure, in this case, may be a bi-stable device where the second portion and the first portion may be undergo relative translational motion between two mechanically stable states. This motion may occur substantially in a plane parallel to the substrate. In some implementations, the first electrodes may be formed on a lateral surface of the first portion and the second electrodes may be formed on lateral surface of the second portion facing the first electrodes. In one configuration of the first portion and the second portion, a larger gap may exist between the first electrodes and the second electrodes, resulting in a state of lower circuit capacitance for the varactor than in another configuration of the first portion and the second portion, in which a smaller gap may exist between the first electrodes and the second electrodes, resulting in a state of higher circuit capacitance for the varactor. The mechanism by which the circuit capacitance is realized in such implementations may be termed a “closing-gap capacitance mechanism” for the purposes of this disclosure.

In another implementation, the second electrodes may be formed on a bottom surface of the second portion and the first electrodes may be formed on a planar substrate to which the first portion is anchored. A gap may exist between the bottom surface of the second portion and the substrate. During relative motion of the second portion with respect to the first portion, the extent to which the second electrodes and first electrodes overlap may vary. The mechanism by which the circuit capacitance is realized in such implementations may be termed a “changing-overlap capacitance mechanism” for the purposes of this disclosure.

In some implementations, the relative translational motion of the second portion and the first portion may be achieved through the use of an actuator or drive mechanism. For example, a comb-drive, a closing-gap actuator, a changing-overlap actuator, or other capacitive actuator mechanism, an electromagnetic drive system, a thermo-mechanical drive system, or a piezoelectric drive system, may be used to linearly displace either the second portion or the first portion with respect to the remaining portion. The actuator or drive mechanism may be located within or external to the periphery of the first portion and the second portion of the varactor.

The drive mechanism may be configured to impart motive force to whichever portion moves with respect to the reference frame of the substrate. For example, in some implementations, the first portion may be fixed relative to the supporting substrate, and the second portion may undergo substantially linear motion with respect to the reference frame of the substrate. As a further example, in some other implementations, the second portion may be fixed relative to the supporting substrate, and the first portion may undergo substantially linear motion with respect to the reference frame of the substrate.

Multiple first and second electrodes may be used, as well as single first and second electrodes. In some implementations, the electrodes may have a high length-to-width aspect ratio and may be oriented with the long axis substantially perpendicular to the direction of the linear motion of the first portion or the second portion. In some implementation, the first and second electrodes may be arranged in an array in order to increase the change in a capacitance associated with a given amount of relative motion between the first and second portion of the varactor.

Particular implementations of the subject matter described in this disclosure can be implemented to realize one or more of the following potential advantages. An in-plane MEMS varactor may be used to implement a number of different electrical circuits, including tunable resonator and impedance matching circuits. In a first example, an in-plane MEMS varactor may be used to provide the capacitor in an inductor-capacitor (LC) resonator circuit that may be capable of resonating at different frequencies depending on the field-tunable circuit capacitance of the in-plane MEMS varactor. Frequency-tunable LC resonators may in turn be used as building blocks to synthesize field-reconfigurable bandpass and bandstop filter circuits. In a second example, the field-tunable circuit capacitance of an in-plane MEMS varactor may be used to synthesize impedance matching network circuits between electronic components such as antennas, amplifiers, filters, and mixers. Field-tunable circuits such as filters and impedance matching networks may be useful for hand-held communications devices, such as wireless handsets, that may need to operate across different ranges of frequencies. The relatively small size of MEMS varactors facilitates their integration into portable electronic devices.

Some implementations of an in-plane MEMS varactor also may be mechanically bi-stable. Such implementations may be advantageous since they may not require the continued application of an actuation force in order to maintain a given capacitance state. Advantages of bi-stable varactor implementations may include reduced power dissipation and mitigating issues with dielectric charging that may occur when capacitive devices are maintained in a small gap or “closed” state under actuation. Yet another advantage of such implementations is the ability, by virtue of their elastic bi-stability, to form the basis for non-volatile logic memory elements.

As mentioned above, some implementations of in-plane MEMS varactors described herein may be used to realize a field-tunable capacitive element in an electronic circuit. One incumbent benefit of tunability is that multi-frequency radio frequency (RF) filters, clock oscillators, impedance matching networks, transducers or other devices, each including one or more in-plane MEMS varactors, depending on the desired implementation, may be fabricated using fewer discrete components or even on the same substrate. Moreover, some implementations of an in-plane MEMS varactor may be co-fabricated with passive components such as resistors and high quality factor (Q) capacitors and inductors. In some implementations, these passive components may include metal-insulator-metal (MIM) type capacitors and through-substrate via solenoid, toroid, spiral, or other inductors. Such implementations may, for example, be advantageous in terms of cost and form factor by enabling compact, multi-band filter and/or broadband impedance-matching solutions for RF front-end applications on a single chip. In some examples, by using in-plane MEMS varactors, as described in greater detail below, components operating at multiple frequencies spanning a range from MHz to GHz may be addressed on the same die.

In a simultaneous fabrication process for forming such co-fabricated structures, one or more processing steps and/or layers may be shared by, for example, the combination of the tunable in-plane MEMS varactor and one or more of the fixed resistor, the high Q capacitor, and the inductor circuit component structures. In some implementations, the one or more shared processing steps and/or layers may be used to create structures, package structures, or form interconnects between structures.

In fabricating some implementations of a combined in-plane MEMS varactor and passive circuit component device, portions of a shared sacrificial (SAC) layer formed of a material such as amorphous silicon (a-Si) or molybdenum (Mo) may be deposited on a substrate such as glass beneath elements of the in-plane MEMS varactor or passive component structure(s). When the SAC layer is released, for instance, by exposing the device to a xenon difluoride (XeF₂) gas or sulfur hexafluoride (SF₆) plasma, gaps may be created such that the elements of, for example, an in-plane MEMS varactor may be spaced apart from the substrate. Such gaps may allow an element of the MEMS varactor to undergo motion relative to the substrate. In some other implementations, the combined varactor and passive circuit component device may use a photo-imageable glass substrate to form a structure. In yet another implementation (Si), a silicon or silicon-on-insulator (SOI) substrate may be used. Finally, in some implementations of the combined varactor and passive circuit component device, the MEMS varactor may be spaced apart from the substrate using a substrate transfer process.

The formation of MEMS varactors and passive circuit components using such MEMS fabrication techniques may reduce the aggregate chip real estate and packaging steps. Parasitic impedance between components also may be reduced, thereby improving signal fidelity and reducing losses. For instance, fabricating a resonator including an inductor and an in-plane MEMS varactor on the same die, as opposed to fabricating the same components on separate dice and connecting them on a separate substrate such as a printed circuit board (PCB) using solder balls, may greatly reduce the parasitic inductance and resistance. Minimizing parasitic inductance may be especially desirable in circuit applications having specifications for relatively small inductances (such as on the order of nanohenries). In general, when one or more MEMS varactors and passive components are fabricated on a shared substrate and in close proximity to one other using one or more of the techniques disclosed herein, parasitic impedance may be substantially reduced in relation to implementations using discrete components. Some implementations of the subject matter described in this disclosure may reduce the number of steps of a fabrication process, as well as a packaging process, for such multi-component systems, particularly since the components can be co-fabricated using shared steps and implemented as a one-chip solution. Lower fabrication costs are often a resulting benefit, as are lower packaging costs, both of which may contribute significantly to reducing the overall product cost.

The disclosed MEMS varactor and passive component structures may be fabricated on the same low-cost, low-loss, large-area insulating substrate, that, in some implementations, may form at least a portion of the structures described herein. In some implementations, the insulating substrate on which the disclosed structures may be formed may be made of display grade glass (such as alkaline earth boro-aluminosilicate), or other glass (such as soda lime glass). Other suitable insulating materials that may be used for an insulating substrate may include silicate glasses, such as alkaline earth aluminosilicate, borosilicate, modified borosilicate, photo-imageable glass and other, similar materials. Insulating substrates also may be provided using ceramic materials such as aluminum oxide (AlOx), yttrium oxide (Y₂O₃), boron nitride (BN), silicon carbide (SiC), aluminum nitride (AlNx), and gallium nitride (GaNx). In some other implementations, the insulating substrate may be formed from silicon. In some implementations, silicon-on-insulator (SOI) substrates, gallium arsenide (GaAs) substrates, indium phosphide (InP) substrates, and plastic (e.g., polyethylene naphthalate, polyethylene terephthalate, etc.) substrates, such as substrates associated with flexible electronics, also may be used. The substrate may be in integrated circuit (IC) wafer form (such as 4 inch, 6 inch, 8 inch, 12 inch diameter wafers), or in large-area panel form. For example, flat panel rectangular display substrates with dimensions such as 370 mm×470 mm, 920 mm×730 mm, and 2850 mm×3050 mm, may be used. In some cases, active devices such as transistors or thin film transistors (TFTs) may be fabricated on the same wafer or large area substrate as the in-plane MEMS varactors.

Various aspects of in-plane MEMS varactors are discussed below with respect to various additional figures in this application. While the various in-plane MEMS varactor implementations described below may exhibit marked topological differences from one another, such implementations do share certain common characteristics. For example, the various in-plane MEMS varactors may all be formed on or in a substrate and be shaped using various deposition, etching, bonding, or other MEMS manufacturing processes.

The in-plane MEMS varactors also may feature a second portion and a first portion that are configured to undergo relative translational motion in a reference plane that is substantially parallel to the plane of the MEMS substrate. In some implementations, the second portion may anchor the in-plane MEMS varactor to the substrate and the first portion may be free to translate. In some other implementations, the first portion may anchor the in-plane MEMS varactor to the substrate and the second portion may be free to translate.

Implementations of an in-plane MEMS varactor also may feature an actuation or drive mechanism that is configured to cause the second portion and the first portion to undergo relative translational motion in a plane that is substantially parallel to the substrate. Such drive mechanisms may, for example, take the form of a capacitive actuation system, a piezoelectric actuation system, an electromagnetic system, or other suitable mechanism. In some implementations, the capacitive gaps defining the capacitive actuation system may be occupied by vacuum, air, or another gas (such as nitrogen (N), argon (Ar), neon (Ne)), or by a liquid (such as mineral oil or other dielectric fluid). The medium within the gap may be chosen in part to engineer the resulting capacitance (and hence the force imparted by the drive mechanism) of the gap and/or the mechanical damping of the in-plane MEMS device.

Implementations of an in-plane MEMS varactor may further feature a variable circuit capacitance mechanism that may provide a capacitance to an external electrical circuit. The variable capacitance mechanism may operate using a closing-gap capacitance mechanism, a changing-overlap capacitance mechanism, or a combination of these two mechanisms. The variable circuit capacitance mechanism may be configured to provide a circuit capacitance that varies with the relative in-plane translation between the second portion and the first portion. In some implementations, the capacitive gaps defining the variable capacitive mechanism may be occupied by vacuum, air or another gas (such as N, Ar, or Ne), or by a liquid (such as mineral oil or other dielectric fluid). The medium within the gap may be chosen in part to engineer the resulting circuit capacitance of the gap and/or the mechanical damping of the in-plane MEMS device.

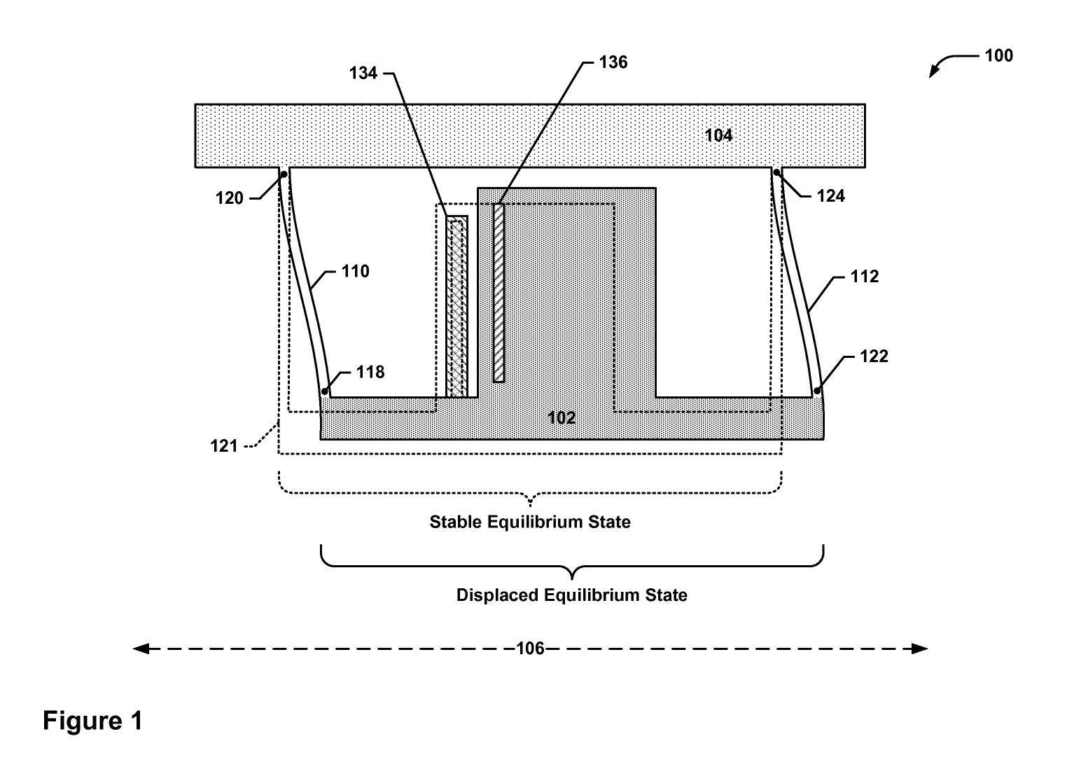

FIG. 1 depicts a plan view of an example of a two-beam in-plane MEMS varactor in a displaced configuration. In FIG. 1, a second portion 102 of an in-plane MEMS varactor 100 may be connected with a first portion 104 by a first beam 110 and by a second beam 112. The second portion 102 may be connected with the first beam 110 at a first end of the first beam 118, and may be connected with the second beam 112 at a first end of the second beam 122. The first portion 104 may be connected with the first beam 110 at a second end of the first beam 120, and may be connected with the second beam 112 at a second end of the second beam 124. The second portion 102 and the first portion 104 may be supported by a substrate (not shown, but generally parallel to the Figure page) and may be generally parallel to the substrate. In the implementation shown, the first portion 104 may serve as an “anchor” and be fixed with respect to the substrate, whereas the second portion 102 may be free to translate with respect to the substrate (subject to the constraints imposed by the first beam 110 and the second beam 112).

In the implementation shown in FIG. 1, the first beam 110 and the second beam 112 may be prismatic beams with substantially rectangular cross-sections and, in an unstressed condition, may be substantially straight. This stable equilibrium state is represented in FIG. 1 by a dotted outline 121. However, due to the elastic properties of the first beam 110 and the second beam 112, when the second portion 102 experiences a net external force that is directed substantially along translation axis 106, the second portion 102 and the first portion 104 may undergo substantially translational motion along the translation axis 106 in proportion to the net force. It is to be understood that “substantially translational motion” in the context of this particular implementation may not only involve translation along the linear axis 106, but also may involve some small amount of translation in a direction perpendicular to the linear axis 106 and parallel to the substrate. This is due to the fixed length of the first beam 110 and the second beam 112.

The in-plane MEMS varactor 100 also may feature a first electrode 134 that is fixed with respect to the first portion 104 and a second electrode 136 that is fixed with respect to the second portion 102. The first electrode 134 and the second electrode 136 may be separated by a gap in the direction normal to the substrate. In this implementation, the relative translation between the first electrode 134 and the second electrode 136 may cause a change in the amount the two electrodes overlap that may cause a corresponding change in the capacitance between the two electrodes. For example, in the stable equilibrium configuration (not shown), the second electrode 136 may completely overlap with the first electrode 134, resulting in a relatively high capacitance state. In the displaced equilibrium configuration shown, however, the second electrode 136 may not overlap the first electrode 134 at all, resulting in a relatively low capacitance state. Other configurations resulting in intermediate degrees of overlap between the first electrodes and the second electrodes may result in intermediate capacitance states that vary as a function of the degree of electrode overlap. Such a device or a network of such in-plane MEMS devices configured to operate across a range of capacitance states may form the basis for an analog varactor. Alternatively, an in-plane MEMS varactor may be configured to provide two distinct capacitance states. A network of such in-plane MEMS devices configured to operate in either of two capacitance states may form the basis for a digital varactor with a discrete number of addressable circuit capacitance values that depends in part on the number of devices in the network.

FIG. 1 does not depict a drive mechanism for applying the actuation force; such drive mechanisms are described later in this disclosure. Since the implementation shown in FIG. 1 may only be maintained in the displaced configuration through the sustained application of the actuation force, the drive mechanism supplying the actuation force may need to be kept energized to maintain the capacitance state associated with the displaced configuration.

Other in-plane MEMS varactor topologies may feature a greater number of beams and be configured to more effectively constrain motion of the second portion and the first portion with respect to each other along a linear translation axis.

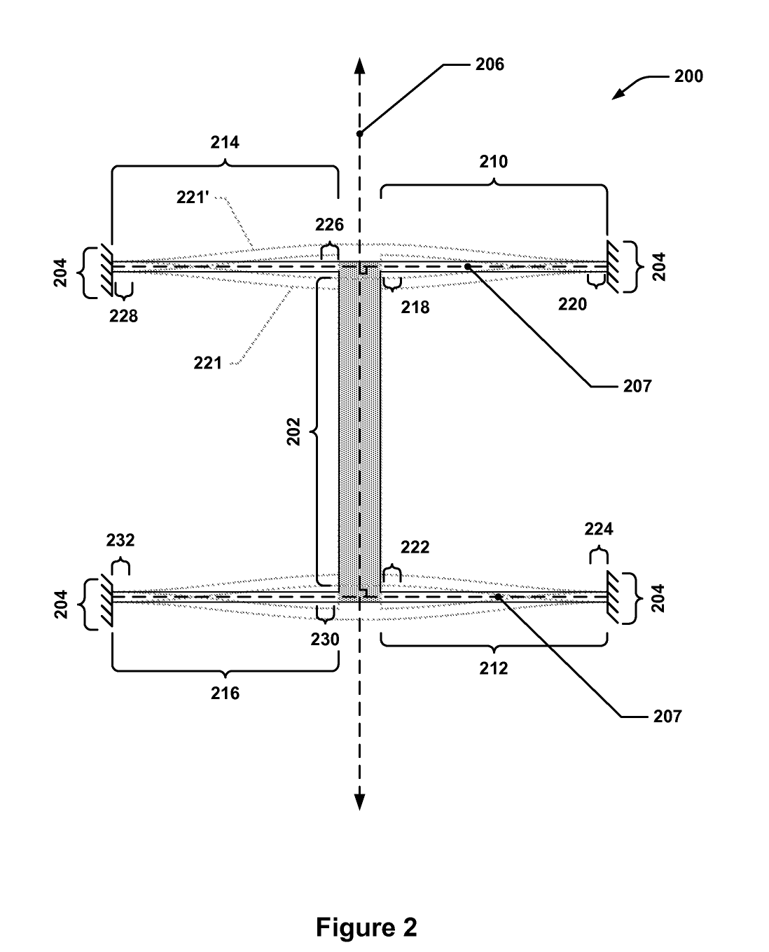

FIG. 2 depicts a plan view of an example of a four-beam in-plane MEMS device 200 that includes a second portion 202 and a first portion 204 (only portions of the first portion 204 are shown). A first beam 210 and a second beam 212 may connect the second portion 202 with the first portion 204 along one side, and a third beam 214 and a fourth beam 216 may connect the second portion 202 with the first portion 204 along an opposite side. The second portion 202 may be connected with the first beam 210 and the second beam 212 at a first end of the first beam 218 and a first end of the second beam 222, respectively, and may be connected with the third beam 214 and the fourth beam 216 at a first end of the third beam 226 and a first end of the fourth beam 230, respectively. Similarly, the first portion 204 may be connected with the first beam 210 and the second beam 212 at a second end of the first beam 220 and a second end of the second beam 224, respectively, and may be connected with the third beam 214 and the fourth beam 216 at a second end of the third beam 228 and a second end of the fourth beam 232, respectively. The first beam 210, the second beam 212, the third beam 214, and the fourth beam 216 may be configured to enable relative motion between the second portion 202 and the first portion 204 substantially along a translation axis 206.

Also visible in FIG. 2 are transverse reference lines 207 spanning between the second end of the first beam 220 and the second end of the third beam 228 and between the second end of the second beam 224 and the second end of the fourth beam 232. In this implementation, the first beam 210, the second beam 212, the third beam 214, and the fourth beam 216 are straight prismatic beams that lie along the transverse reference lines 207 when in the stable equilibrium configuration, similar to the first beam 110 and the second beam 112 of FIG. 1. While FIG. 2 shows the in-plane MEMS varactor 200 in an un-displaced configuration, dotted outlines 221 and 221′ show the second portion 202, the first beam 210, the second beam 212, the third beam 214, and the fourth beam 216 in two opposing displaced configurations. Such displaced configurations may be achieved by applying an external actuation force to the second portion 202 and anchoring the first portion 204 to the substrate. In some other implementations, such displaced states may be achieved by applying an external actuation force to the first portion 204 and anchoring the second portion 202 to the substrate. In order to maintain either of the depicted displaced states, it may be necessary to maintain the external actuation force.

FIG. 2 does not show various other features that may be included in an in-plane MEMS varactor, such as a substrate to support the overall MEMS structure, electrodes that provide the variable circuit capacitance and mechanisms for imparting an external actuation force; such features are discussed later in this disclosure.

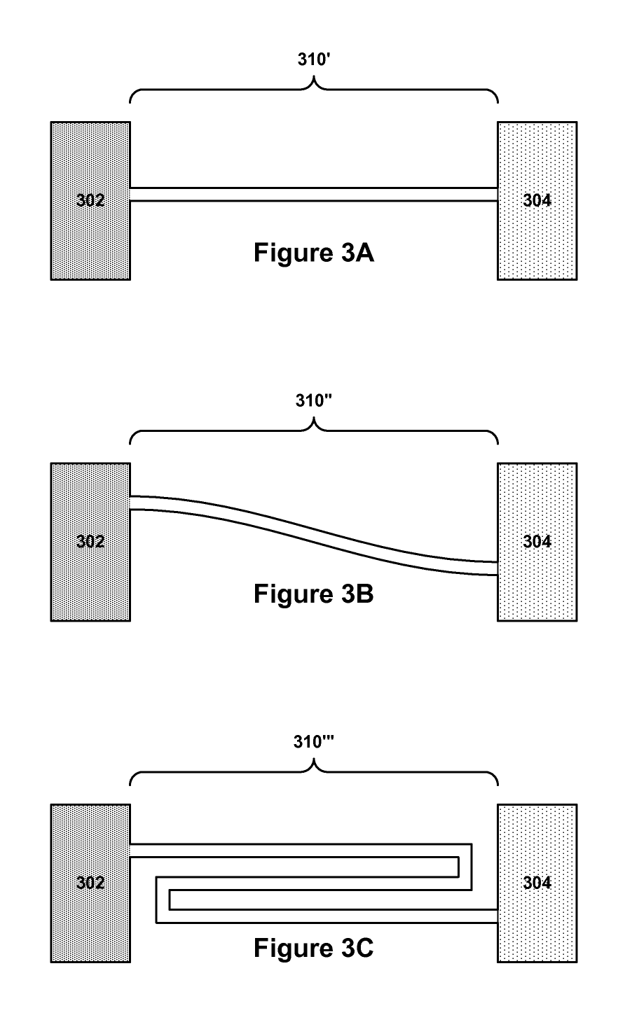

In the implementations discussed above, various topologies of beam elements are used to prescribe constrained, relative in-plane motion between the second portions and the first portions of various in-plane MEMS varactors and devices. Some examples of beam element topologies that may be suitable for such a purpose are discussed below with respect to FIGS. 3A through 3C.

FIG. 3A depicts a plan view of an example of a straight prismatic beam structure with fixed-fixed ends. A prismatic beam can refer to a beam that has a substantially constant cross-section along its length (such as a beam with a substantially rectangular cross section or a rod with a substantially circular cross section). In this context, a fixed end condition implies substantially zero displacement and substantially zero slope at the end (such as the root of a cantilever beam). As can be seen in FIG. 3A, a second portion 302 and a first portion 304 may be joined by a straight, prismatic beam 310′. In some implementations, however, beams of a non-constant cross section (i.e., non-prismatic beams) may be used.

FIG. 3B depicts a plan view of an example of a beam structure with a shape substantially corresponding to one half of the first buckling mode shape of a straight prismatic beam structure with fixed-fixed ends. As can be seen in FIG. 3B, the second portion 302 and the first portion 304 may be joined by a beam 310″ having a shape generally corresponding to one half of the first buckling mode shape of a prismatic beam of substantially similar cross section and approximately twice the length of the beam 310″. The beam 310″ may possess this half-first buckling mode shape while in an unstressed state.

FIG. 3C depicts a plan view of an example of a folded beam structure with fixed-fixed ends. In FIG. 3C, the second portion 302 and the first portion 304 may be joined by a beam 310′″ that includes at least one beam element that is “folded” back on an adjoining beam element. The depicted beam 310′″ includes three beam elements, and two fold points, although fewer or more beam elements also may be used. Folded beam topologies may be used to provide additional degrees of freedom for realizing a desired bending stiffness within a given footprint.

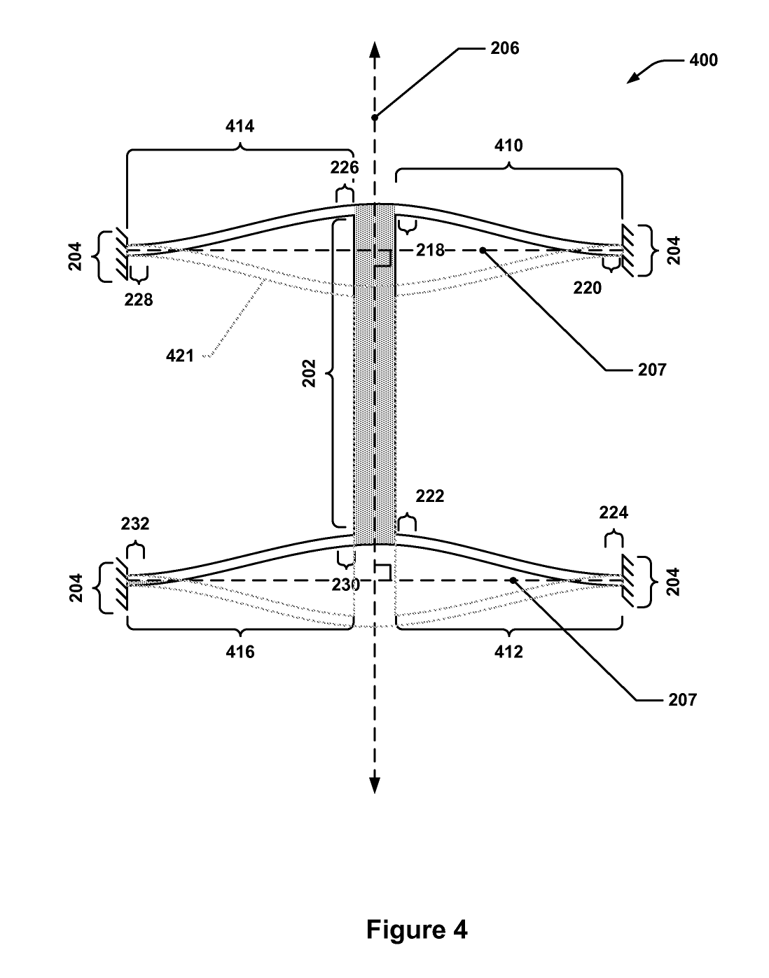

FIG. 4 depicts a plan view of another example of a four-beam in-plane MEMS device 400. Many of the structures shown in FIG. 4 correspond to the structures shown in FIG. 2, and are similarly numbered. However, the first beam 210, the second beam 212, the third beam 214, and the fourth beam 216 of FIG. 2 have been replaced with a first beam 410, a second beam 412, a third beam 414, and a fourth beam 416, respectively, all of which are curved beams similar in shape to beam 310″ shown in FIG. 3B and discussed above (i.e., these beams may each have a shape substantially corresponding to one-half of the shape of the first buckling mode of a prismatic beam of similar cross-section). Such an arrangement may result in two elastically stable equilibrium configurations—one such as that shown in FIG. 4, and another in which the second portion 202 has been shifted along the translation axis 206 such that the first beam 410, the second beam 412, the third beam 414, and the fourth beam 416 are substantially located on opposite sides of the transverse reference lines 207 from the positions they are depicted in in FIG. 4 (indicated by the gray dotted line outline 421 in FIG. 4). Whereas the in-plane MEMS device 200 required the continuous application of an external actuation force in order to maintain either of the two pictured displaced configurations, the in-plane MEMS device 400 only requires the application of a displacement force to transition between the two elastically stable equilibrium configurations. Once at rest in either of the two elastically stable equilibrium configurations, no further external actuation force is required to remain in the equilibrium configuration.

As with FIG. 2, FIG. 4 does not show various other features that may be included in an in-plane MEMS varactor, such as a substrate to support the overall MEMS structure, electrodes that provide the variable circuit capacitance, and mechanisms for imparting an external actuation force; such features are discussed later in this disclosure.

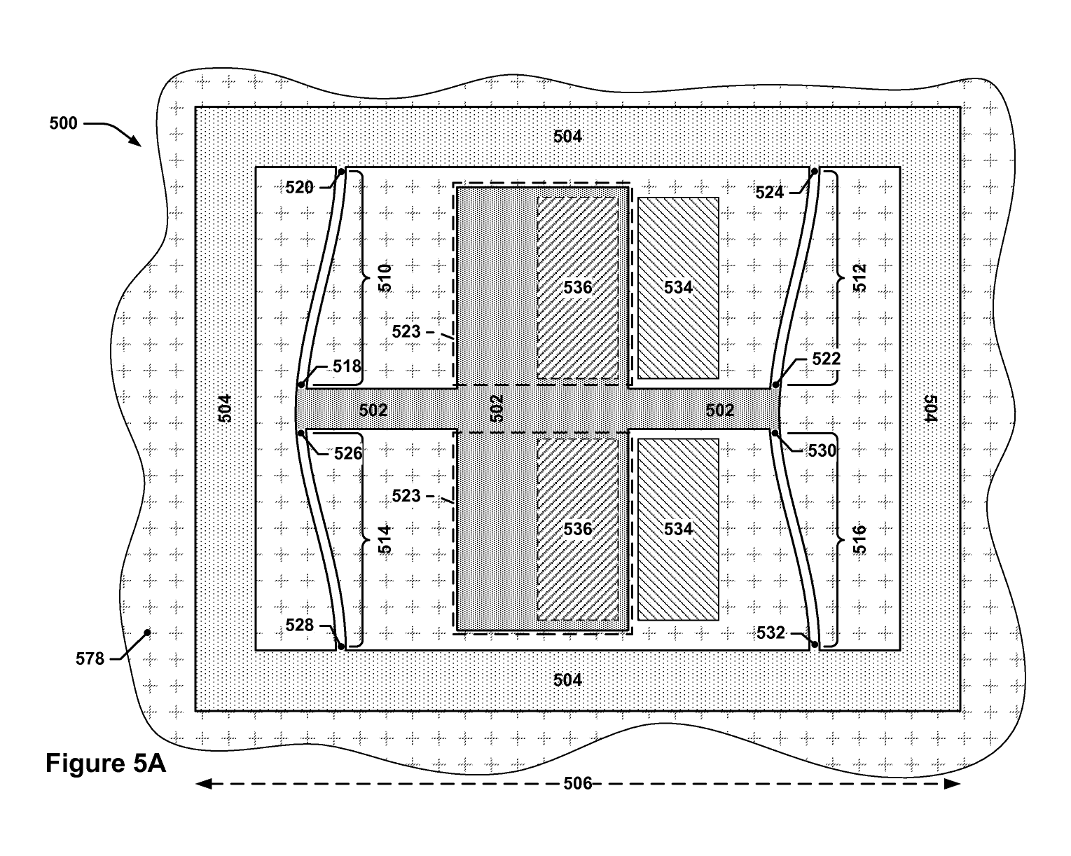

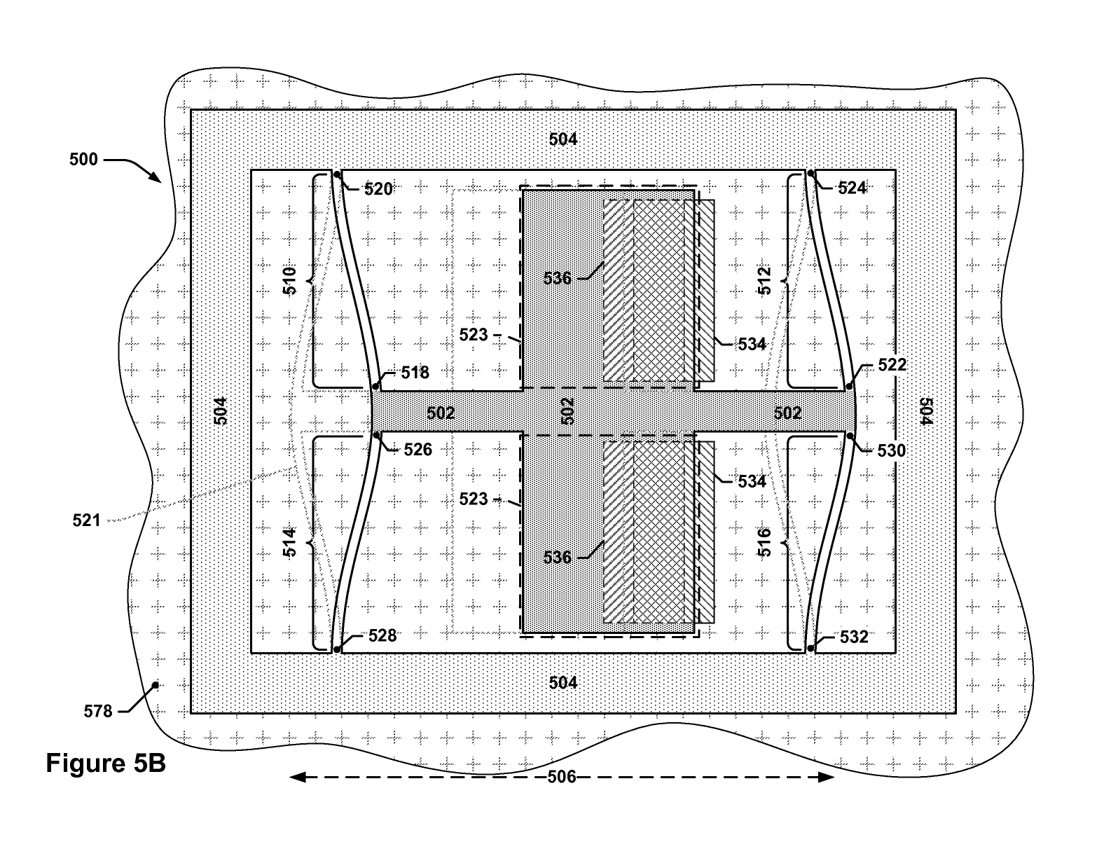

FIG. 5A depicts a plan view of an example of a four-beam in-plane MEMS varactor that produces a variable circuit capacitance through a changing-overlap capacitance mechanism. An in-plane MEMS varactor 500 may include a second portion 502 and a first portion 504. A first beam 510 and a second beam 512 may connect the second portion 502 to the first portion 504 along one side, and a third beam 514 and a fourth beam 516 may connect the second portion 502 to the first portion 504 along an opposite side. The second portion 502 may be connected with the first beam 510 and the second beam 512 at a first end of the first beam 518 and a first end of the second beam 522, respectively, and may be connected with the third beam 514 and the fourth beam 516 at a first end of the third beam 526 and a first end of the fourth beam 530, respectively. Similarly, the first portion 504 may be connected with the first beam 510 and the second beam 512 at a second end of the first beam 520 and a second end of the second beam 524, respectively, and may be connected with the third beam 514 and the fourth beam 516 at a second end of the third beam 528 and a second end of the fourth beam 532, respectively.

In the implementation pictured, the first portion 504 may be may be fixed with respect to a substrate 578 and the second portion 502 may be supported by the first portion 504 by means of the first beam 510, the second beam 512, the third beam 514, and the fourth beam 516. First electrodes 534 also may be fixed with respect to the substrate 578; consequently, the first electrodes 534 also may be fixed relative to the first portion 504. In some other implementations that are not depicted, the second portion 502 may be fixed with respect to the substrate 578 and the first portion 504 may be supported by the second portion 502 by means of the first beam 510, the second beam 512, the third beam 514, and the fourth beam 516.

The structure of the second portion 502, the first portion 504, the first beam 510, the second beam 512, the third beam 514, and the fourth beam 516 may be configured to allow relative translational motion between the second portion 502 and the first portion 504. The resulting motion may be substantially constrained to a direction parallel to translation axis 506 in a plane substantially parallel to the substrate 578. Furthermore, if the first beam 510, the second beam 512, the third beam 514, and the fourth beam 516 are all curved beams each having a shape substantially corresponding to one-half of the shape of the first buckling mode of a prismatic beam of similar cross-section, then the second portion 502 and the first portion 504 may have two elastically-stable equilibrium configurations. In this context, an elastically-stable equilibrium configuration is a relative displacement between the second portion 502 and the first portion 504 that, once assumed, may be sustained in the absence of subsequent actuation effort. Thus, an in-plane MEMS varactor 500 having two elastically-stable equilibrium configurations may be a mechanically bi-stable device. As discussed above, a drive mechanism may be used to supply the actuation force that is necessary to impart relative motion between the second portion 502 and the first portion. Such a drive mechanism is not shown in FIG. 5A or 5B, but example drive mechanisms are discussed later in this disclosure.

As can be seen, the second portion 502 may include regions 523 extending towards the interior lateral surfaces of the first portion 504 to which the first beam 510, the second beam 512, the third beam 514, and the fourth beam 516 are connected. The regions 523 may not contact the first portion 504, but may provide a relatively large area within which second electrodes 536 may be situated. The second electrodes 536 may be located on the underside of the second portion 502 (i.e., facing the substrate 578) and within the regions 523 such that the first electrodes 534 and the second electrodes 536 at least partially overlap when the first portion 504 and the second portion 502 are in at least one of the two bi-stable configurations. In some implementations, one of the bi-stable configurations of the in-plane MEMS varactor 500 may correspond to a low-capacitance state of the circuit capacitance of the varactor and the other bi-stable configuration may correspond to a high-capacitance state of the circuit capacitance of the varactor. In FIG. 5A, a low-capacitance state is depicted. As can be seen, there is no overlap between the first electrode 534 and the second electrode 536 in the depicted low-capacitance state. However, in other implementations, there may be overlap in both the high-capacitance and the low-capacitance states. In some implementations, the low-capacitance state may be used as a digital “zero” or “one” and the high-capacitance state may be used as a complementary digital “1” or “zero” (e.g., as the bits in a binary logic circuit). The degree of overlap between the first electrodes 534 and the second electrodes 536 in the low-capacitance state may be determined based, for example, on the location of the first electrodes 534 and the second electrodes 536 with respect to each other and on the size of the first electrodes 534 and the second electrodes 536.

FIG. 5B depicts a plan view of the example of the four-beam in-plane MEMS varactor from FIG. 5A in a high-capacitance configuration. As can be seen, the second portion 502 has been shifted to the right along the translation axis 506 with respect to the first portion 504, flexing the first beam 510, the second beam 512, the third beam 514, and the fourth beam 516, and causing the first electrodes 534 and the second electrodes 536 to at least partially overlap, in this case, by more than 50%. The original position of the second portion (i.e., the position shown in FIG. 5A) is represented by a gray dotted outline 521 for clarity.

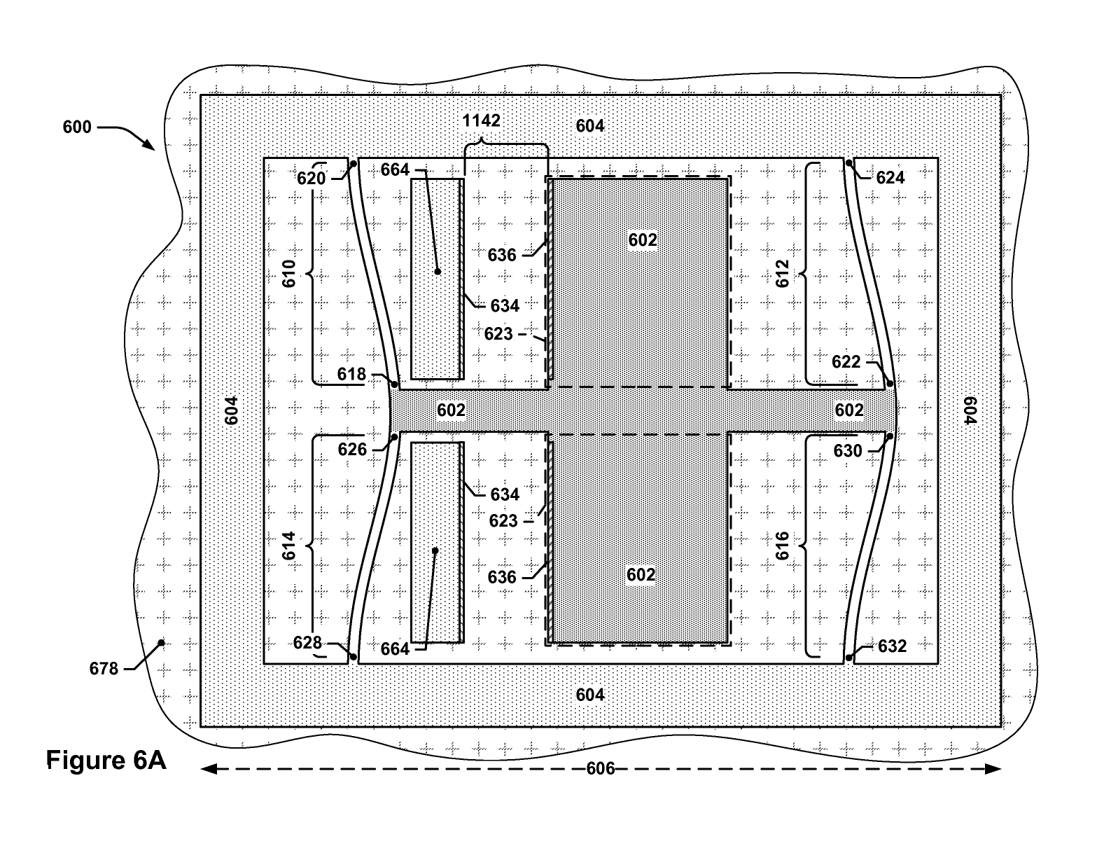

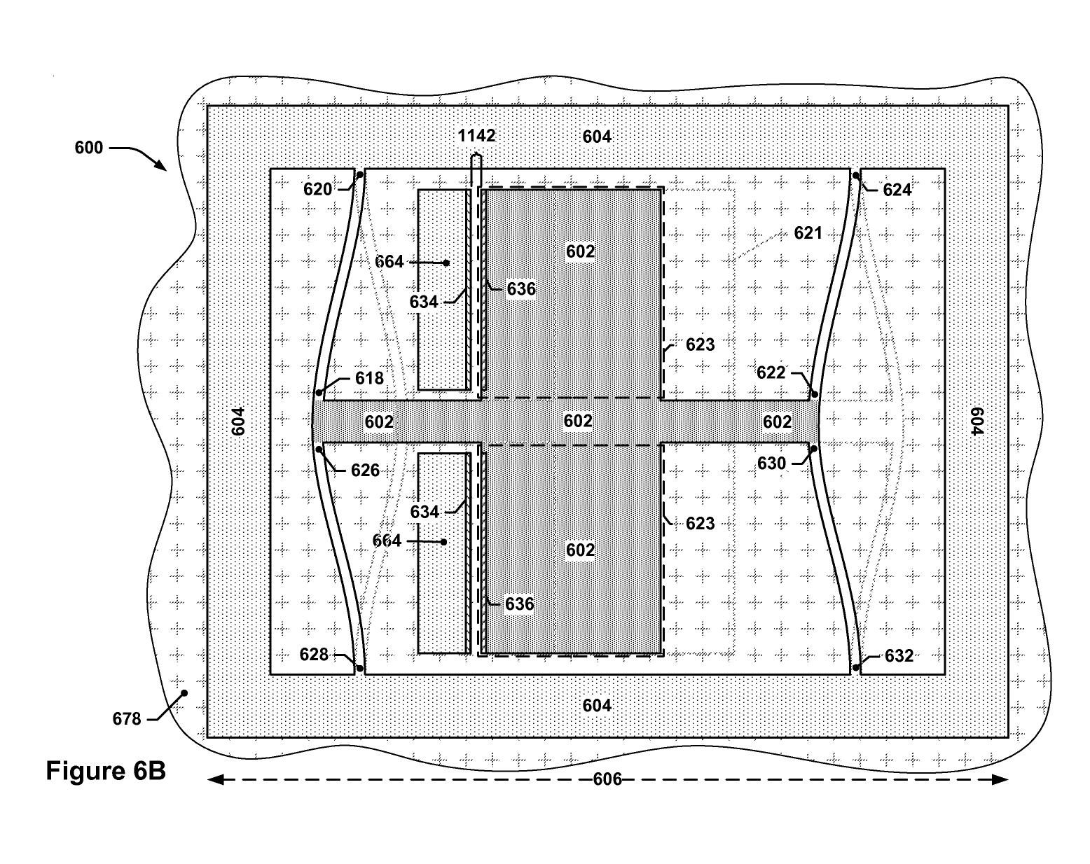

Other implementations of mechanically bi-stable in-plane MEMS varactors may employ alternative mechanisms to produce a variable circuit capacitance. FIG. 6A depicts a plan view of an example of a four-beam in-plane MEMS varactor that produces a variable circuit capacitance through a closing-gap capacitance mechanism. In FIG. 6A, the MEMS varactor is depicted in a low-capacitance configuration. FIG. 6B depicts a plan view of the example of the four-beam in-plane MEMS varactor from FIG. 6A in a high-capacitance configuration.

Many of the structures shown in FIGS. 6A and 6B are similar to those shown in FIGS. 5A and 5B. For example, a four-beam in-plane MEMS varactor 600 may include a second portion 602 and a first portion 604. A first beam 610 and a second beam 612 may connect the second portion 602 to the first portion 604 along one side of the second portion, and a third beam 614 and a fourth beam 616 may connect the second portion 602 to the first portion 604 along an opposite side of the second portion. The second portion 602 may be connected with the first beam 610 and the second beam 612 at a first end of the first beam 618 and a first end of the second beam 622, respectively, and may be connected with the third beam 614 and the fourth beam 616 at a first end of the third beam 626 and a first end of the fourth beam 630, respectively. Similarly, the first portion 604 may be connected with the first beam 610 and the second beam 612 at a second end of the first beam 620 and a second end of the second beam 624, respectively, and may be connected with the third beam 614 and the fourth beam 616 at a second end of the third beam 628 and a second end of the fourth beam 632, respectively.

In the depicted implementation, the first portion 604 may be fixed with respect to a substrate 678 and the second portion 602 may be supported by the first portion 604 by means of the first beam 610, the second beam 612, the third beam 614, and the fourth beam 616. Capacitance electrode posts 664 may protrude from the substrate 678. First electrodes 634 may be located on lateral surfaces of capacitance electrode posts 664; consequently, the first electrodes 634 also may be fixed relative to the first portion 604. In some implementations, the normal to the first electrodes 634 may be substantially parallel to a translation axis 606. In some other implementations that are not depicted, the second portion 602 may be fixed the substrate 678 and the first portion 604 may be supported by the second portion 602 by means of the first beam 610, the second beam 612, the third beam 614, and the fourth beam 616.

Analogous to FIGS. 5A and 5B, the structure of the second portion 602, the first portion 604, the first beam 610, the second beam 612, the third beam 614, and the fourth beam 16 may be configured to allow relative translational motion between the second portion 602 and the first portion 604. The resulting motion may be substantially constrained to a direction parallel to translation axis 606 in a plane substantially parallel to the substrate 678. Furthermore, if the first beam 610, the second beam 612, the third beam 614, and the fourth beam 616 are all curved beams each having a shape substantially corresponding to one-half of the shape of the first buckling mode of a prismatic beam of similar cross-section, then the second portion 602 and the first portion 604 may have two elastically-stable equilibrium positions. As discussed above, a drive mechanism may be used to supply the actuation force that is necessary to impart relative motion between the second portion 602 and the first portion 604. Such a drive mechanism is not shown in FIG. 6A or 6B, but example drive mechanisms are discussed later in this disclosure.

As with the second portion 502, the second portion 602 also may include a region 623 extending towards the interior lateral surfaces of the first portion 604 to which the first beam 610, the second beam 612, the third beam 614, and the fourth beam 616 are connected. The regions 623 may not contact the first portion 604, but may provide location for supporting second electrodes 636. The second electrodes 636 may, for example, be located on lateral surfaces of the second portion 602 that face the first electrodes 634 and also may have surface normals that are substantially parallel to the translation axis 606.

In FIG. 6A, a first gap 642 between the first electrodes 634 and the second electrodes 636 may be relatively large and may correspond to a low-capacitance state of the varactor circuit capacitance. FIG. 6B depicts a plan view of the example four-beam in-plane MEMS varactor from FIG. 6A in which the second portion 602 has been shifted to the left such that the first gap 642 between the first electrodes 634 and the second electrodes 636 is substantially smaller (i.e., “closing” the first gap 642). The decrease in gap distance may cause the capacitance between the first electrodes 634 and the second electrodes 636 to increase resulting in a high-capacitance state of the varactor circuit capacitance. The position of the second portion corresponding to the low-capacitance state of FIG. 6A is represented by a gray dotted outline 621 for clarity in FIG. 6B.

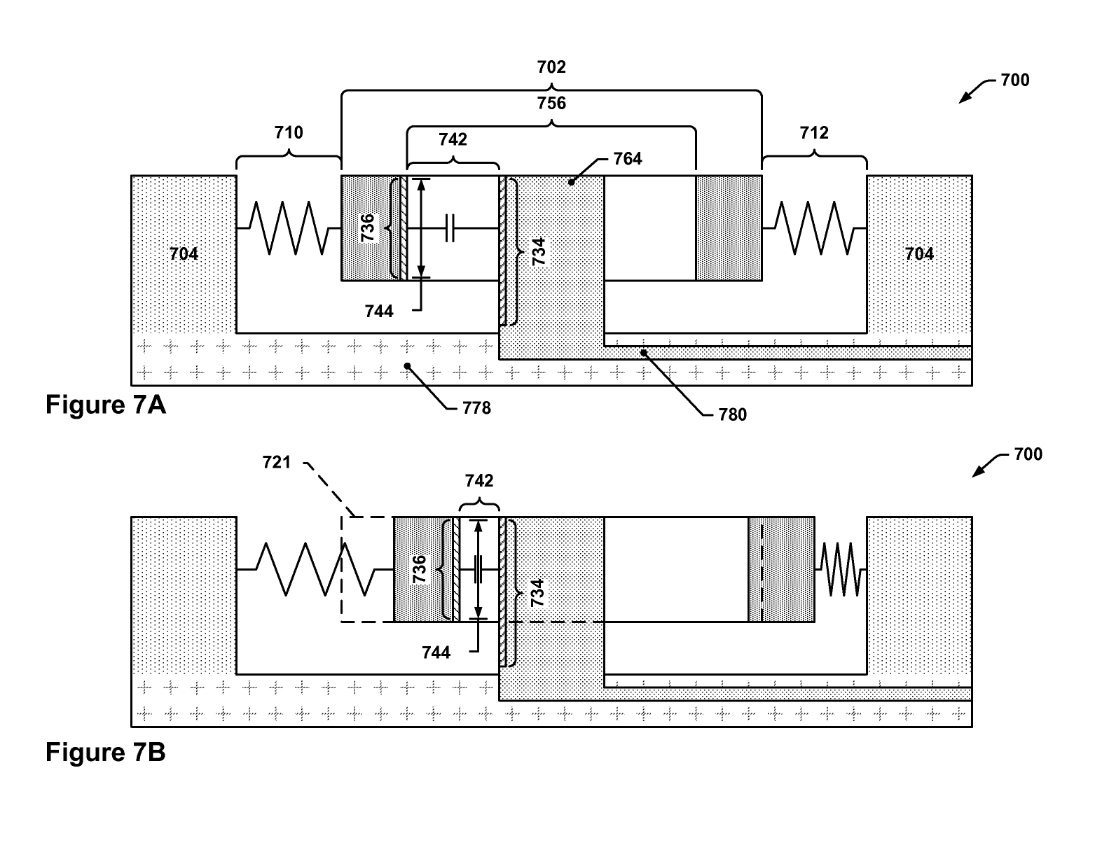

Further discussion of the variable circuit capacitance mechanisms discussed previously with respect to FIGS. 5A through 6B will now be made with respect to FIGS. 7A through 9B.

FIG. 7A depicts a cross-sectional view of an example of a conceptual varactor that produces a variable circuit capacitance through a closing-gap capacitance mechanism. An in-plane MEMS varactor 700 may include a substrate 778, a first portion 704 that is fixed with respect to the substrate 778, and a second portion 702 that is connected with a first portion 704 by a first beam 710 and a second beam 712. The first beam 710 and the second beam 712 may be configured to allow relative motion between the second portion 702 and the first portion 704 by undergoing elastic deformation. The first beam 710 and the second beam 712 further may be configured to constrain the motion of the second portion 702 to a plane that is substantially parallel to the substrate 778. The first beam 710 and the second beam 712 are depicted as a discrete spring element in FIG. 7A, which, in practice, may be realized as a flexural elastic element such as a beam or another appropriate elastic element. Some implementations may employ more than two beams, for example four beams, to connect the second portion 702 to the first portion 704. Each beam may be formed as a contiguous part of the overall in-plane MEMS varactor 700 structure that includes the second portion 702 and the first portion 704.

The second portion 702 may include an opening 756. In some implementations, the opening 756 may be an elongated rectangular slot (as could be seen in a plan view) with a long axis perpendicular to the page. The in-plane MEMS varactor 700 may further include a capacitive electrode post 764 that is fixed with respect to the substrate 778 and protrudes into the opening 756. A first electrode 734 may be located on a lateral surface of the capacitive electrode post 764 and may, in turn, be electrically connected to a capacitive electrode routing 780 that is fixed with respect to the substrate 778. In some implementations, the capacitive electrode post 764 may be formed of a conductive material, in which case a lateral surface of the capacitive electrode post 764 may impart the functionality of the first electrode 734 (i.e., the capacitive electrode post 764 and the first electrode 734 may be formed as a monolithic structure).

Also visible in FIG. 7A is second electrode 736 that may be located on a lateral surface of the opening 756 within the second portion 702 facing the first electrode 734. The first electrode 734 and the second electrode 736 may be separated by a first gap 742. The size of the first gap 742 may change when the second portion 702 and the first portion 704 undergo relative motion with respect to one another. In some implementations, the second portion 702 may be formed of a conductive material, in which case a lateral surface of the second portion 702 may impart the functionality of the second electrode 736 (i.e., the second portion 702 and the second electrode 736 may be formed as a monolithic structure).

The first electrode 734 and the second electrode 736 also may overlap each other over a first overlap area 744. In some implementations of a closing-gap variable capacitance mechanism, the first overlap area 744 may remain substantially unchanged during relative motion between the second portion 702 and the first portion 704.

FIG. 7B depicts a cross-sectional view of the example of the conceptual in-plane varactor of FIG. 7A in a high-capacitance configuration. As can be seen, the second portion 702 has moved to the right, thereby reducing the size of the first gap 742, which, in turn, increases the capacitance between the first electrode 734 and the second electrode 736 as compared to the configuration shown in FIG. 7A. The dashed outline 721 represents the position of the second portion 702 as depicted in FIG. 7A. Not shown in either FIG. 7A or 7B is a drive mechanism to actuate relative motion between the second portion 704 and the first portion 702; examples of drive mechanisms are discussed elsewhere in this disclosure.

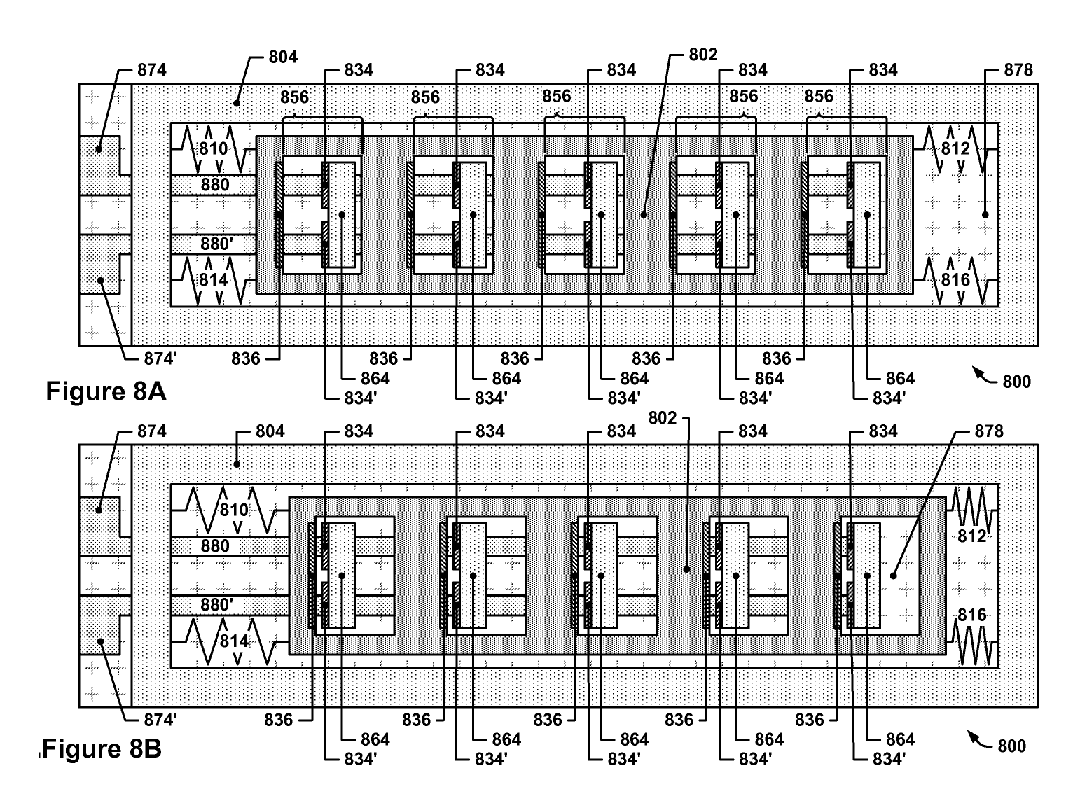

FIG. 8A depicts a plan view of an example of an in-plane varactor that produces a variable circuit capacitance through a closing-gap capacitance mechanism. Visible in FIG. 8A is an in-plane varactor 800 with a substrate 878, a first portion 804 that is fixed with respect to the substrate, and a second portion 802 that is connected with first portion 804 by, for example, a first beam 810, a second beam 812, a third beam 814, and a fourth beam 816. The second portion 802 and the first portion 804 may be in a plane that is substantially parallel to the substrate 878. In some implementations, such as the one depicted in FIG. 8A, the first portion 804 may substantially surround the second portion 802. The second portion 802 may include a number of elongated slots 856. The first beam 810, the second beam 812, the third beam 814, and the fourth beam 816 may be configured to allow relative motion between the second portion 804 and the first portion 802 by undergoing elastic deformation. The first beam 810, the second beam 812, the third beam 814, and the fourth beam 816 are depicted as discrete spring elements in FIG. 8A, which, in practice, may be realized as a flexural elastic element such as a beam or another appropriate elastic element. Each beam may be formed as a contiguous part of the overall in-plane MEMS varactor 800 structure that includes the second portion 802 and the first portion 804.

The in-plane MEMS varactor 800 further also may include a capacitive electrode post 864 that is fixed with respect to the substrate 878. Each capacitive electrode post 864 may protrude into an elongated slot 856. Each capacitance electrode post 864 may support a first electrode 834 and first electrode 834′ on a lateral surface with a normal that is parallel to the direction of the relative motion between the second portion 802 and the first portion 804. The first electrodes 834 may be conductively connected with capacitive electrode routing 880, and the first electrodes 834′ may be conductively connected with capacitive electrode routing 880′. The capacitive electrode routing 880 and 880′ may be fixed with respect to the substrate 878 and substantially conductively isolated from each other. The capacitive electrode routings 880 and 880′ may terminate at terminals 874 and 874′, respectively. The electrical connectivity may be such that the terminal 874, the electrode routing 880, and the first electrode 834 may be substantially at a first electrical potential and that the terminal 874′, the electrode routing 880′, and the first electrode 834′ may be substantially at a second electrical potential. The in-plane varactor 800 may be configured to provide a variable circuit capacitance between terminals 874 and 874′.

Each of the elongated slots 856 may have a second electrode 836 located on a lateral surface of the elongated slot 856 facing the first electrodes 834 and 834′. In the depicted in-plane varactor 800, the second electrodes 836 are floating shunt electrodes (i.e., they are not tied to a specific electrical potential). A variable circuit capacitance between terminals 874 and 874′ may result from the series combination of a first capacitance between a first electrode 834 and a second electrode 836 and of a second capacitance between a first electrode 834′ and a second electrode 836. In some implementations, the first capacitance and the second capacitance may be substantially equal and vary as a function of the size of the gap between the first electrodes 834 and 834′ and the second electrode 836. Accordingly, FIG. 8A depicts the in-plane varactor 800 in a low-capacitance state.

FIG. 8B depicts the example of the in-plane varactor of FIG. 8A in a high-capacitance configuration. As can be seen, the second portion 802 has been translated to the right relative to the first portion 804 and the substrate 878 by a drive mechanism (not shown). The displaced configuration results in a smaller gap, and consequently a larger capacitance, between the second electrodes 836 and the first electrodes 834 and between the second electrodes 836 and the first electrodes 834′. Thus, the variable circuit capacitance between terminals 874 and 874′ may be increased with respect to the variable circuit capacitance of the configuration shown in FIG. 8A.

Implementations of an in-plane varactor using floating shunt electrodes that are fixed with respect to a movable portion of the varactor may obviate the need to route conductive traces between a movable portion of the varactor and a non-moving portion of the varactor (i.e., those portions that are fixed with respect to a substrate). This feature may simplify the design and manufacturing process of such an in-plane varactor.

The second portion 802 may support an arbitrary number of the elongated slots 856 and the second electrodes 836, and the substrate 878 may support a corresponding number of the capacitive electrode posts 864 and the first electrodes 834 and the first electrodes 834′. Taken together, each of the elongated slot 856s and the corresponding second electrodes 836, capacitive electrode posts 864, first electrodes 834 and first electrodes 834′ may provide a single unit cell of variable circuit capacitance. Thus, the in-plane MEMS varactor 800 may include an arbitrary number of variable circuit capacitance unit cells in parallel in order to scale the effective circuit capacitance that is presented at terminals 874 and 874′. Although the depicted in-plane MEMS varactor 800 includes five variable circuit capacitance unit cells arranged in a linear array, it is to be understood that other numbers of variable circuit capacitance unit cells alternatively may be arranged in 1-dimensional or 2-dimensional arrays (or other, non-array patterns).

In some implementations, a changing-overlap capacitance mechanism may be used as an alternative or in addition to a closing-gap variable circuit capacitance mechanism such as that shown in FIGS. 7A and 7B.

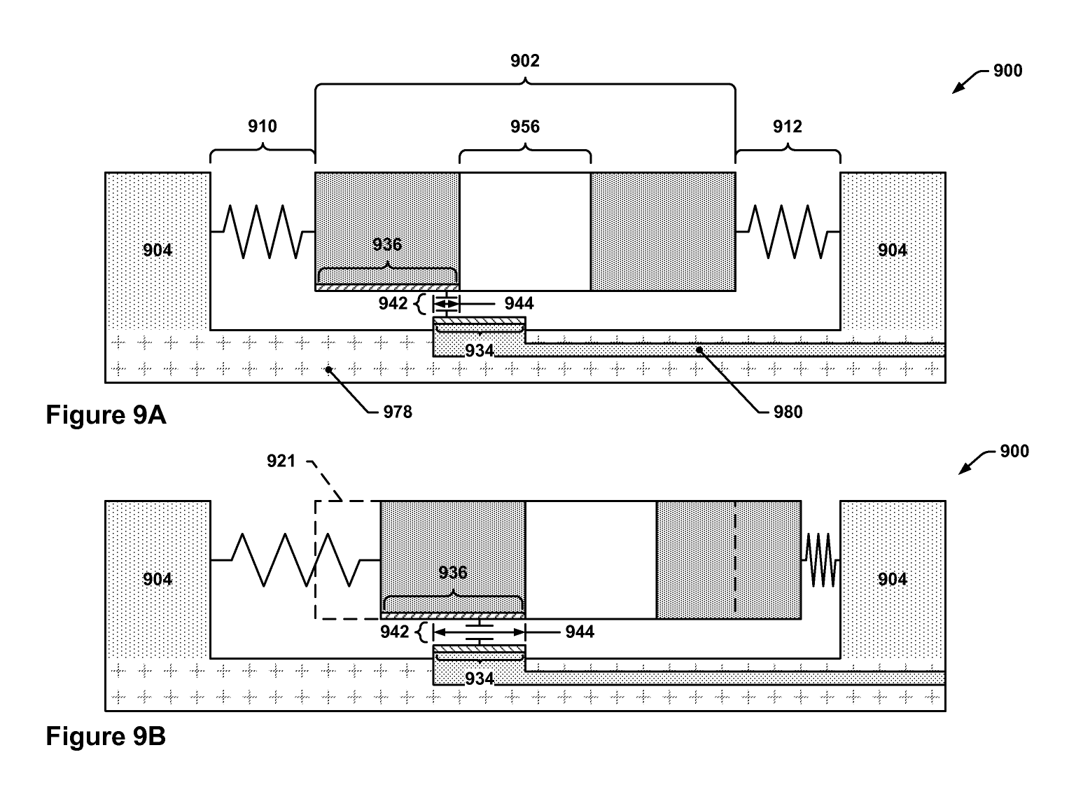

FIG. 9A depicts a cross-sectional view of an example of a conceptual in-plane varactor that produces a variable circuit capacitance through a changing-overlap variable capacitance mechanism. Similar to the in-plane MEMS varactor 700 shown in FIGS. 7A and 7B, an in-plane MEMS varactor 900 may include a substrate 978, a first portion 904 that is fixed with respect to the substrate 978, and a second portion 902 that is connected with the first portion 904 by a first beam 910 and a second beam 912. The first beam 910 may be configured to allow relative motion between the second portion 902 and the first portion 904 by undergoing elastic deformation. The first beam 910 and the second beam 912 may be further configured to constrain the motion of the second portion 902 to a plane that is substantially parallel to the substrate 978. The first beam 910 and the second beam 912 are depicted as a discrete spring element in FIG. 9A, which, in practice, may be realized as a flexural elastic element such as a beam or another appropriate elastic element. Some implementations may employ more than two beams, for example four beams, to connect the second portion 902 to the first portion 904. Each beam may be formed as a contiguous part of the overall in-plane MEMS varactor 900 structure that includes the second portion 902 and the first portion 904.

The second portion 902 may include an opening 956. In some implementations, the opening 956 may be an elongated rectangular slot (as could be seen in a plan view) with a long axis perpendicular to the page. The in-plane MEMS varactor 900 may further include a first electrode 934 and capacitive electrode routing 980. In some implementations, the first electrode 934 may be fixed with respect to a substrate 978 and arranged substantially parallel to a bottom surface of the second portion 902. The capacitive electrode routing 980 also may be fixed with respect to the substrate 978 and may be electrically connected to the first electrode 934.

Also visible in FIG. 9A is a second electrode 936 that may be located on a bottom surface of the second portion 902 adjacent to the opening 956 and facing the first electrode 934. The first electrode 934 and the second electrode 936 may be separated by a first gap 942. In some implementations, the size of the first gap 942 may remain substantially constant as the second portion 902 and the first portion 904 undergo relative motion with respect to one another. In some implementations, the second portion 902 may be formed of a conductive material, in which case a bottom surface of the second portion 902 may impart the functionality of the second electrode 936 (i.e., the second portion 902 and the second electrode 936 may be formed as a monolithic structure).

The first electrode 934 and the second electrode 936 also may overlap each other across a first overlap area that is characterized by an overlap length 944. The first overlap length 944, and hence the overlap area, may vary as a function of the relative motion between the second portion 902 and the first portion 904.

FIG. 9B depicts a cross-sectional view of the example of the conceptual in-plane varactor of FIG. 9A in a high-capacitance configuration. As can be seen, the second portion 902 has moved to the right, causing the first overlap length 944, and hence the overlap area, to increase. The increase in overlap area in turn increases the capacitance between the first electrode 934 and the second electrode 936, which causes an increase in the circuit capacitance of the in-plane MEMS varactor 900. The dashed outline 921 represents the position of the second portion as depicted in FIG. 9A. Although the drive mechanism to actuate relative motion between the second portion 904 and the first portion 902 is not depicted in FIG. 9A or 9B, it is discussed elsewhere in this disclosure.

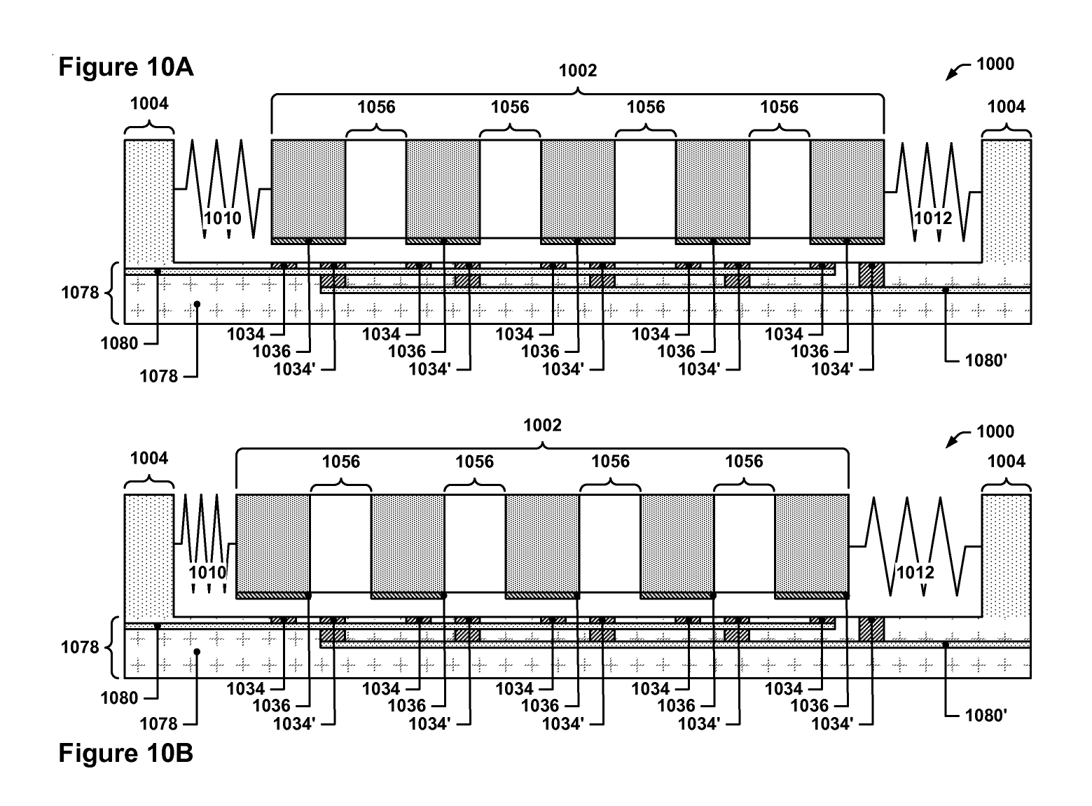

FIG. 10A depicts a cross-sectional view of an example of an in-plane varactor that produces a variable circuit capacitance through a changing-overlap capacitance mechanism. Visible in FIG. 10A is an in-plane varactor 1000 with a substrate 1078, a first portion 1004 that is fixed with respect to the substrate 1078, and a second portion 1002 that is connected with the first portion 1004 by a first beam 1010 and a second beam 1012. The second portion 1002 and the first portion 1004 may be in a plane that is substantially parallel to the substrate 1078. In some implementations such as the one depicted, the first portion 1004 may substantially surround the second portion 1002.

The first beam 1010 and the second beam 1012 may be configured to allow relative motion between the second portion 1002 and the first portion 1004 by undergoing elastic deformation. The first beam 1010 and the second beam 1012 further may be configured to constrain the motion of the second portion 1002 to a plane that is substantially parallel to the substrate 1078. The first beam 1010 and the second beam 1012 are depicted as discrete springs in FIG. 10A, which, in practice, may be realized as a flexural elastic element such as beams or other appropriate elastic elements. Some implementations may employ more than two beams, for example four or six beams, or odd numbers of beams, for example, three beams, to connect the second portion 1002 to the first portion 1004. Each beam may be formed as a contiguous part of the overall in-plane MEMS varactor 1000 structure that includes the second portion 1002 and the first portion 1004.

The second portion 1002 may include a number of elongated slots 1056 that separate a number of second electrodes 1036 on a bottom surface of the second portion 1002. The in-plane MEMS varactor 1000 further may include the first electrode 1034 and the first electrode 1034′ that are fixed with respect to a substrate 1078, and capacitive electrode routing 1080 and capacitive electrode routing 1080′ that also are fixed with respect to the substrate 1078. In some implementations, electrical connections may be made between a first electrode 1034 and the capacitive electrode routing 1080, and between a first electrode 1034′ and the capacitive electrode routing 1080′, respectively. In some cases it may be desirable that the capacitive electrode routing 1080 and the capacitive electrode routing 1080′ be substantially electrically isolated from one another. In such cases, the electrical isolation between the capacitive electrode routing 1080 and the capacitive electrode routing 1080′ may be achieved by distancing the elements from each other laterally, by separating the elements with a dielectric layer in the thickness direction, by combinations thereof, or by alternative methods.

In the in-plane varactor 1000, the first electrode 1034 and the first electrode 1034′ face the left side of the corresponding second electrode 1036 and the right side of the corresponding second electrode 1036, respectively. In the depicted in-plane varactor 1000, the second electrodes 1036 are floating shunt electrodes (i.e., they are not tied to a specific electrical potential). A variable circuit capacitance between capacitive electrode routing 1080 and capacitive electrode routing 1080′ may be the result of the series combination of a first capacitance between the first electrode 1034 and the corresponding second electrode 1036 and of a second capacitance between the first electrode 1034′ and the corresponding second electrode 1036. In some implementations the first capacitance and the second capacitance may vary as a function of the amount of overlap between the first electrodes 1034 and 1034′ and the second electrode 1036. For example, the configuration of the in-plane MEMS varactor 1000 depicted in FIG. 10A shows the first electrodes 1034 and the first electrodes 1034′ fully overlapped by the corresponding second electrodes 1036. Accordingly, FIG. 10A depicts the in-plane varactor 1000 in a high-capacitance state.

FIG. 10B depicts the example of the in-plane varactor of FIG. 10A in a low-capacitance configuration. As can be seen, the second portion 1002 has been translated to the left relative to the first portion 1004 and the substrate 1078 by a drive mechanism (not shown). In the displaced configuration, the second electrodes 1036 no longer overlap the first electrodes 1034′, but the second electrodes 1036 still fully overlap the first electrodes 1034. Consequently, the capacitance between the first electrode 1034′ and the second electrode 1036 may be greatly decreased (the capacitance due to fringing fields remains even in the absence of overlap), and the capacitance between the first electrode 1034 and the second electrode 1036 may remain substantially unchanged. Thus, the overall circuit capacitance of the in plane-varactor 1000 as shown in FIG. 10B is lower than in the configuration depicted in FIG. 10A.

As previously discussed in the context of an in-plane varactor that produces a variable circuit capacitance through a closing-gap capacitance mechanism, the implementations of an in-plane varactor using floating shunt electrodes that are fixed with respect to a movable portion of the varactor (as depicted in FIGS. 10A and 10B) may obviate the need to route conductive traces between a movable portion of the varactor and a non-moving portion of the varactor (i.e., those portions that are fixed with respect to the substrate). This feature may simplify the design and manufacturing process of such an in-plane varactor.

The second portion 1002 may support an arbitrary number of the elongated slots 1056 and the second electrodes 1036, and the substrate 1078 may support a corresponding number of the first electrodes 1034 and the first electrodes 1034′. Taken together, each of the elongated slots 1056 and the corresponding second electrodes 1036, first electrodes 1034 and first electrodes 1034′ may provide a single unit cell of variable circuit capacitance. Thus, the in-plane MEMS varactor 1000 may include an arbitrary number of variable circuit capacitance unit cells in order to scale its effective circuit capacitance. Although the depicted in-plane MEMS varactor 1000 includes five variable circuit capacitance unit cells arranged in a linear array, it is to be understood that other numbers of variable circuit capacitance unit cells alternatively may be arranged in 1-dimensional or 2-dimensional arrays (or in other non-array patterns).

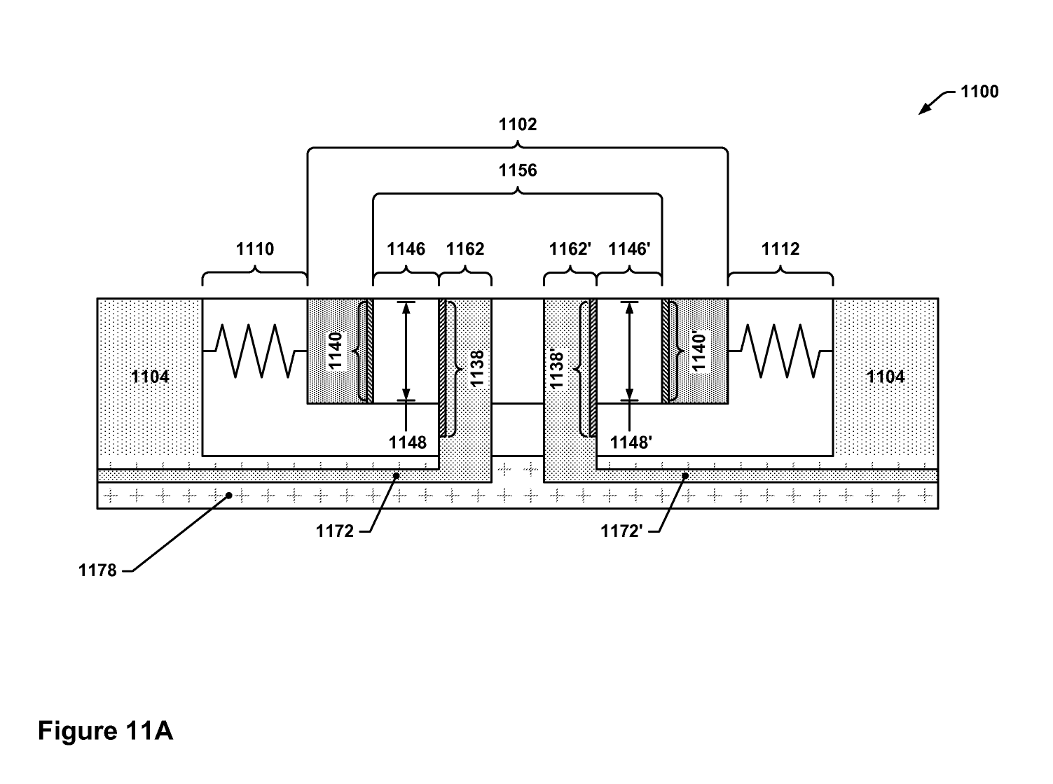

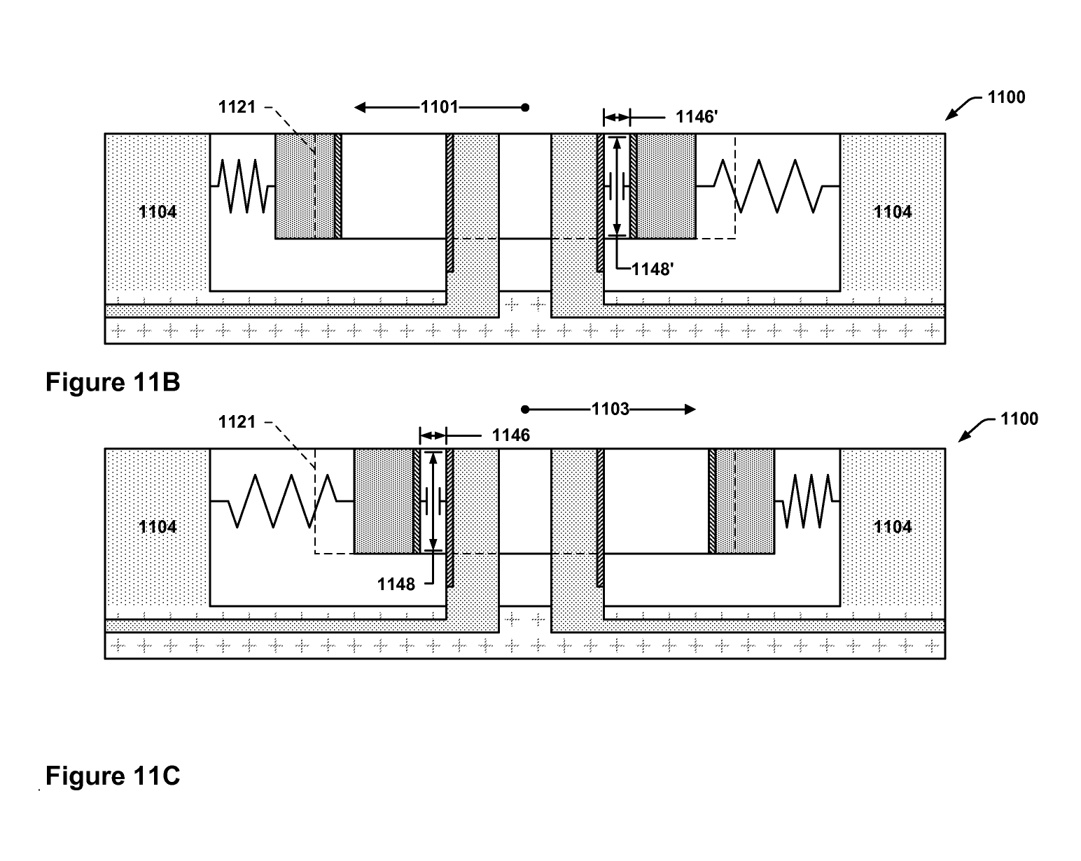

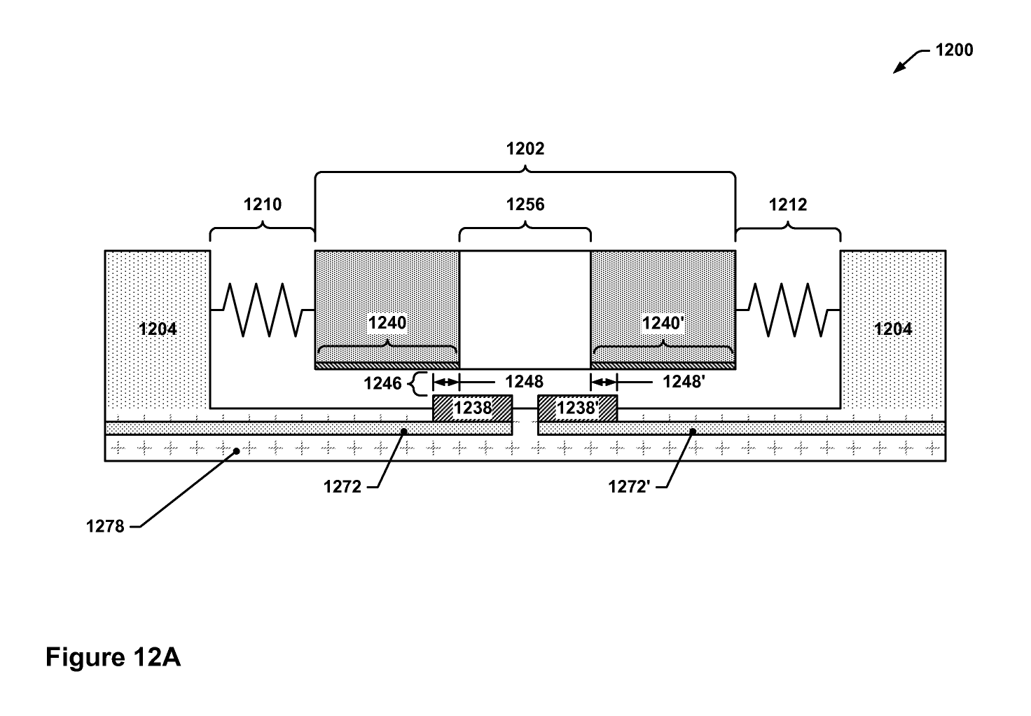

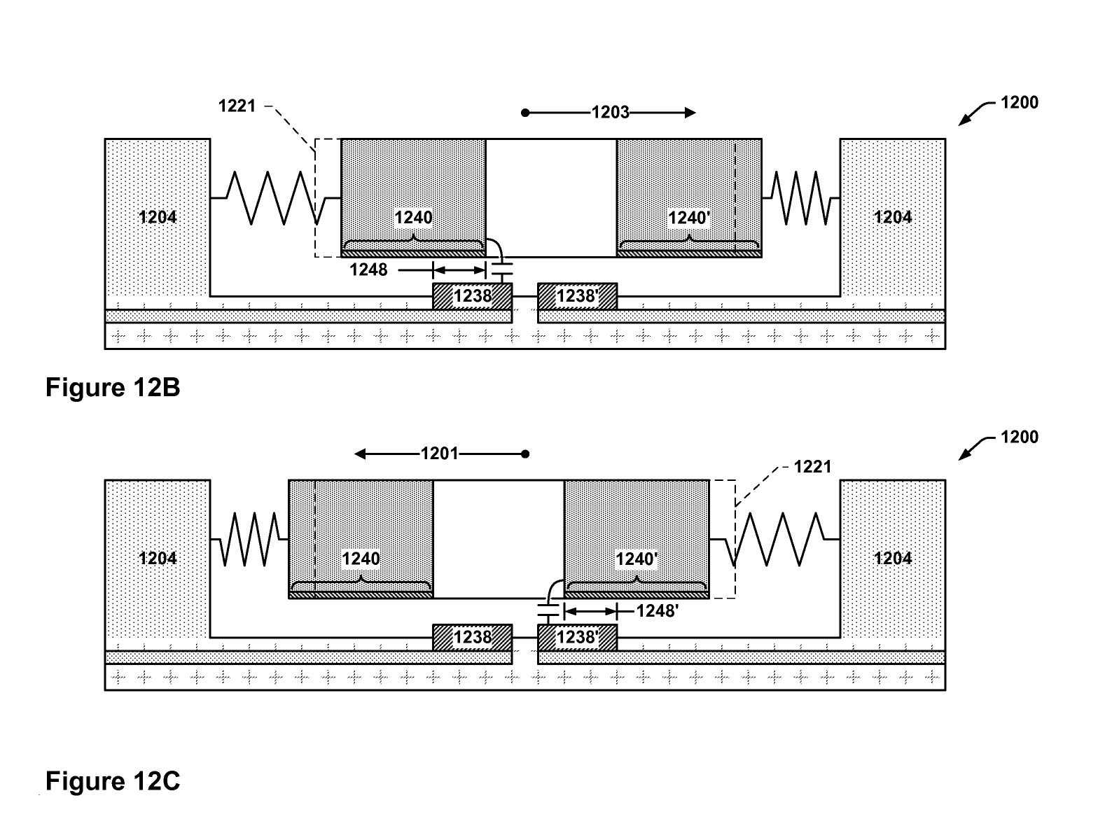

As noted in the discussions above, relative motion between the second portions and the first portions of an in-plane MEMS varactor may be imparted by a drive mechanism. Various types of drive mechanisms may be used, including capacitive drive mechanisms, piezoelectric linear or bending actuators, rack-and-pinion drives, solenoids, or other suitable mechanisms or combinations of mechanisms. These drive mechanisms may be implemented on the same scale as the EMS (such as NEMS or MEMS-scale). The drive mechanisms may be integrated into the in-plane MEMS varactor in a number of ways. Some specific implementations of drive mechanisms are discussed below with respect to FIGS. 11A through 12C. Although FIGS. 11A through 12C do not depict the elements of an in-plane MEMS varactor that are used to provide variable circuit capacitive output, it is to be understood that in-plane MEMS varactors, as described elsewhere in this disclosure, will include such elements for providing a variable circuit capacitance and the elements for providing an actuation mechanism.

FIG. 11A depicts a cross-sectional view of an example of a conceptual in-plane varactor that uses a closing-gap actuation mechanism that may be used to produce translational motion in the conceptual in-plane varactor. An in-plane MEMS varactor 1100 may include a substrate 1178, a first portion 1104 that is fixed with respect to a substrate 1178, and a second portion 1102 that is connected with the first portion 1104 by a first beam 1110 and a second beam 1112.

The second portion 1102 may include an opening 1156. In some implementations, the opening 1156 may be an elongated slot. For example, the opening 1156 in FIG. 11A may be an elongated rectangular slot (as seen in a plan view) with a shorter dimension that is depicted in cross section and a longer dimension that is perpendicular to the plane of the page. Although a slot is an example of an opening that is fully enclosed within the second portion 1102, the opening 1156 may not be fully enclosed in some implementations.

The first beam 1110 and the second beam 1112 may be configured to allow relative motion between the second portion 1102 and the first portion 1104 by undergoing elastic deformation. The first beam 1110 and the second beam 1112 may be further configured to constrain the motion of the second portion 1102 to a plane that is substantially parallel to the substrate 1178. The first beam 1110 and the second beam 1112 are depicted as a discrete spring elements in FIGS. 11A through 11C, and, in practice may be realized as a flexural elastic element such as a beam or another appropriate elastic element. Some implementations may employ more than two beams to connect the second portion 1102 to the first portion 1104. Each beam may be formed as a contiguous part of the overall in-plane MEMS varactor 1100 structure that includes the second portion 1102 and the first portion 1104.

The in-plane MEMS varactor 1100 may further include actuation electrode posts 1162 and 1162′ that are parallel to each other, fixed with respect to the substrate 1178, and that protrude into the opening 1156 in the second portion 1102. A third electrode 1138 and 1138′ may be located on opposite lateral surfaces an actuation electrode post 1162 and 1162′, respectively. The third electrodes 1138 and 1138′ may, in turn, be electrically connected to actuation electrode routings 1172 and 1172′, respectively, that are themselves fixed with respect to the substrate 1178. In some implementations, the actuation electrode posts 1162 and 1162′ may be formed of a conductive material, in which case lateral surfaces of the actuation electrode posts 1162 and 1162′ may impart the functionality of the third electrode 1138 and 1138′ (i.e., actuation electrode post 1162 and 1162′ and the third electrode 1138 and 1138′, respectively, may be formed as monolithic structures).

Also visible in FIG. 11A are fourth electrodes 1140 and 1140′ that may be located on lateral surfaces of the second portion 1102 facing the third electrodes 1138 and 1138′, respectively. The third electrode 1138 and the fourth electrode 1140 may be separated by a second gap 1146. Similarly, the third electrode 1138′ and the fourth electrode 1140′ may be separated by a second gap 1146′. The size of the second gaps 1146 and 1146′ may change when the second portion 1102 and the first portion 1104 undergo relative motion with respect to one another. In some implementations, the second portion 1102 may be formed of a conductive material, in which case lateral surfaces of the second portion 1102 may impart the functionality of the fourth electrodes 1140 and 1140′ (i.e., the second portion 1102 and the fourth electrodes 1140 and 1140′ may be formed as a monolithic structure).

The third electrodes 1138 and 1138′ and the fourth electrodes 1140 and 1140′ also may overlap each other over second overlap areas 1148 and 1148′, respectively. In some implementations of a closing-gap variable capacitance mechanism, the second overlap areas 1148 and 1148′ may remain substantially unchanged during relative motion between the second portion 1102 and the first portion 1104.

FIG. 11B depicts a cross-sectional view of the example of the in-plane varactor of FIG. 11A with the second portion actuated to the left (as denoted by the arrow 1101). Applying a voltage difference between the third electrode 1138′ and the fourth electrode 1140′ produces an electrostatic force that pulls the second portion 1102 to the left towards the first portion 1104, thereby attempting to reduce the size of the second gap 1146′. The electrostatic force acting across the second gap 1146′ may be opposed by an elastic restoring force in the first beam 1110 and the second beam 1112; static equilibrium configurations of the varactor 1100 may occur for configurations in which the net resultant force acting on the system is zero (i.e., when the electrostatic force and the elastic force are “equal and opposite”). In some implementations, it may be desirable to tie the third electrode 1138 to the same potential as the second portion 1102 when actuating the second portion 1102 to the left. The dashed outline 1121 represents the position of the second portion 1102 in the configuration depicted in FIG. 11A.

FIG. 11C depicts a cross-sectional view of the example of the in-plane varactor of FIG. 11A with the second portion actuated to the right (as denoted by the arrow 1103). Applying a voltage difference between the third electrode 1138 and the fourth electrode 1140 produces an electrostatic force that pulls the second portion 1102 to the right towards the first portion 1104, thereby attempting to reduce the size of the second gap 1146. The electrostatic force acting across the second gap 1146 may be opposed by an elastic restoring force in the first beam 110 and the second beam 1112; static equilibrium configurations of the varactor 1100 may occur for configurations in which the net resultant force acting on the system is zero (i.e., when the electrostatic force and the elastic force are “equal and opposite”). In some implementations, it may be desirable to tie the third electrode 1138′ to the same potential as the second portion 1102 when actuating the second portion 1102 to the right. The dashed outline 1121 represents the position of the second portion 1102 in the configuration depicted in FIG. 11A.

The second portion 1102 may support an arbitrary number of the openings 1156 and the fourth electrodes 1140 and 1140′, and the substrate 1178 may support a corresponding number of the actuation electrode posts 1162 and 1162′ and the third electrodes 1138 and 1138′. Taken together, each of the openings 1156 and the corresponding fourth electrodes 1140 and 1140′, actuation electrode posts 1162 and 1162′, third electrodes 1138 and 1138′ may provide a single unit cell of capacitive actuation. Thus, a closing-gap actuation mechanism for an in-plane MEMS varactor 1100 may include an arbitrary number of capacitive actuation unit cells in order to scale the effective actuation force that is available to impart relative motion between the second portion 1102 and the first portion 1104. Although the depicted closing-gap actuation mechanism for the in-plane MEMS varactor 1100 includes one capacitive actuation unit cell, it is to be understood that greater numbers of capacitive actuation unit cells alternatively may be arranged in 1-dimensional or 2-dimensional arrays.

Another type of capacitive actuation mechanism that may be used to impart relative motion in an in-plane varactor is a changing-overlap actuation mechanism. FIG. 12A depicts a cross-sectional view of an example of a conceptual changing-overlap capacitive actuation mechanism that may be used to produce translational motion in an in-plane varactor. An in-plane MEMS varactor 1200 may include a substrate 1278, a first portion 1204 that is fixed with respect to a substrate 1278, and a second portion 1202 that is connected with the first portion 1204 by a first beam 1210 and a second beam 1212.

The second portion 1202 may include an opening 1256. In some implementations, the opening 1256 may be an elongated slot. For example, the opening 1256 in FIG. 12a may be an elongated rectangular slot (as seen in a plan view) with a shorter dimension that is depicted in cross section and a longer dimension that is perpendicular to the plane of the page. Although a slot is an example of an opening that is fully enclosed within the second portion 1202, the opening 1256 may not be fully enclosed in some implementations.

The first beam 1210 and the second beam 1212 may be configured to allow relative motion between the second portion 1202 and the first portion 1204 by undergoing elastic deformation. The first beam 1210 and the second beam 1212 further may be configured to constrain the motion of the second portion 1202 to a plane that is substantially parallel to the substrate 1278. The first beam 1210 and the second beam 1212 are depicted as a discrete spring elements in FIG. 12A, which, in practice, may be realized as a flexural elastic element such as a beam or another appropriate elastic element. Some implementations may employ more than two beams to connect the second portion 1202 to the first portion 1204. Each beam may be formed as a contiguous part of the overall in-plane MEMS varactor 1200 structure that includes the second portion 1202 and the first portion 1204.

The in-plane MEMS varactor 1200 may further include third electrodes 1238 and 1238′, and actuation electrode routings 1272 and 1272′. In some implementations, the third electrodes 1238 and 1238′ may be fixed with respect to the substrate 1278 and arranged substantially parallel to a bottom surface of the second portion 1202. The actuation electrode routing 1272 also may be fixed with respect to the substrate 1278 and may be electrically connected to the third electrode 1238. Similarly, the actuation electrode routing 1272′ also may be fixed with respect to the substrate 1278 and may be electrically connected to the third electrode 1238′.

Also visible in FIG. 12A are fourth electrodes 1240 and 1240′ that may be located on a bottom surface of the second portion 1202 and facing the third electrodes 1238 and 1238′, respectively. The third electrode 1238 and the fourth electrode 1240 may be separated by a second gap 1246. Similarly, the third electrode 1238′ and the fourth electrode 1240′ may be separated by a second gap 1246′. In some implementations, the size of the second gap 1246 and 1246′ may remain substantially constant as the second portion 1202 and the first portion 1204 undergo relative motion with respect to one another. In some implementations, the second portion 1202 may be formed of a conductive material, in which case the bottom surface of the second portion 1202 may impart the functionality of the second electrodes 1240 and 1240′ (i.e., the second portion 1202 and the second electrodes 1240 and 1240′ may be formed as a monolithic structure).

The third electrode 1238 and the fourth electrode 1240 may overlap each other across a second overlap area that is characterized by an overlap length 1248. Similarly, the third electrode 1238′ and the fourth electrode 1240′ may overlap each other across a second overlap area that is characterized by an overlap length 1248′. The second overlap lengths 1248 and 1248′, and hence the overlap areas, may vary as a function of the relative motion between the second portion 1202 and the first portion 1204.

FIG. 12B depicts a cross-sectional view of the example of the conceptual changing-overlap capacitive actuation mechanism of FIG. 12A with the second portion of the in-plane varactor actuated to the right (as denoted by arrow 1203). Applying a voltage difference between the third electrode 1238 and the fourth electrode 1240 may produce an electrostatic force that pulls the second portion 1202 to the right towards the first portion 1204, thereby attempting to increase the size of the second overlap area characterized by the second overlap length 1248. The electrostatic force acting across the second gap 1246 may be opposed by an elastic restoring force in the first beam 1210 and the second beam 1212; static equilibrium configurations of the varactor 1200 may occur for configurations in which the net resultant force acting on the system is zero (i.e., when the electrostatic force and the elastic force are “equal and opposite”). In some implementations, it may be desirable to tie the third electrode 1238′ to the same potential as the second portion 1202 when actuating the second portion to the right. The dashed outline 1221 represents the position of the second portion 1102 in the configuration depicted in FIG. 12A.

FIG. 12C depicts a cross-sectional view of the example of the conceptual changing-overlap capacitive actuation mechanism of FIG. 12A with the second portion actuated to the left (as denoted by arrow 1201). Applying a voltage difference between the third electrode 1238′ and the fourth electrode 1240′ may produce an electrostatic force that pulls the second portion 1202 to the left towards the first portion 1204, thereby attempting to increase the size of the second overlap area characterized by the second overlap length 1248′. The electrostatic force acting across the second gap 1246′ may be opposed by an elastic restoring force in the first beam 1210 and the second beam 1212; static equilibrium configurations of the varactor 1200 may occur for configurations in which the net resultant force acting on the system is zero (i.e., when the electrostatic force and the elastic force are “equal and opposite”). In some implementations, it may be desirable to tie the third electrode 1238 to the same potential as the second portion 1202 when actuating the second portion 1202 to the right. The dashed outline 1221 represents the position of the second portion 1202 in the configuration depicted in FIG. 12A.

The second portion 1202 may support an arbitrary number of the openings 1256 and the fourth electrodes 1240 and 1240′, and the substrate 1278 may support a corresponding number of the third electrodes 1238 and 1238′. Taken together, each of the openings 1256 and the corresponding fourth electrodes 1240 and 1240′ and the third electrodes 1238 and 1238′ may include a single unit cell of capacitive actuation. Thus, a changing-overlap actuation mechanism for the in-plane MEMS varactor 1200 may include an arbitrary number of capacitive actuation unit cells in order to scale the effective actuation force that is available to impart relative motion between the second portion 1202 and the first portion 1204. Although the depicted changing-overlap actuation mechanism for the in-plane MEMS varactor 1200 includes one capacitive actuation unit cell, it is to be understood that greater numbers of capacitive actuation unit cells alternatively may be arranged in 1-dimensional or 2-dimensional arrays.

The in-plane MEMS varactors 1100 and 1200 of FIGS. 11A through 11C and 12A through 12C, respectively, are depicted with bidirectional capacitive actuation mechanisms. Accordingly, the second portions 1102 and 1202 may be actuated to the left by applying a potential between the third electrode 1138′ and the fourth electrode 1140′, and between the third electrode 1238′ and the fourth electrode 1240, respectively. Similarly, the second portions 1102 and 1202 may be actuated to the right by applying a potential between the third electrode 1138 and the fourth electrode 1140, and between the third electrode 1238 and the fourth electrode 1240, respectively. However, in some implementations of in-plane MEMS varactors, a unidirectional capacitive actuation mechanism may be used. For example, a first portion and a second portion of an in-plane varactor may be actuated relative to each other in one direction by applying a potential between a third electrode and a fourth electrode, and relative motion in the opposite direction may be imparted by the elastic restoring force in a beam joining the first portion to the second portion.

Some implementations of the in-plane varactors 1100 and 1200 shown in FIGS. 11A to 11C and FIGS. 12A to 12C may be configured to have two mechanically stable configurations, i.e., be mechanically bi-stable, as described elsewhere in this disclosure. When configured for mechanically bi-stable operation, the configurations shown in FIGS. 11A and 12A may represent unstable configurations that the in-plane MEMS varactors 1100 and 1200 may traverse when transitioning between mechanically bi-stable configurations depicted in FIGS. 11B and 11C and FIGS. 12B and 12C, respectively. In other words, the in-plane MEMS varactors 1100 and 1200 can maintain the configurations depicted in FIGS. 11B and 11C and FIGS. 12B and 12C, respectively, in the absence of an external actuation force, but cannot maintain the configurations depicted in FIG. 11A and FIG. 12A in the absence of such an external actuation force. In some implementations of mechanically bi-stable in-plane MEMS varactors, a bidirectional actuator may be used as described above.

As discussed previously, drive mechanisms other than capacitive drive mechanisms may be used as well to actuate the in-plane MEMS varactor. While no detailed discussion of such other drive mechanisms is provided herein, it is to be understood that in-plane MEMS varactors that make use of such alternative drive mechanisms are contemplated and should be viewed as falling within the scope of this disclosure.

The first electrode(s) and the second electrode(s), as well as the electrical routing to the first electrode(s) and second electrode(s), may be arranged in a number of different configurations depending on the particular implementation of an in-plane MEMS varactor that is used. While some of the implementations discussed above with respect to various Figures may have depicted only one or two first electrodes and second electrodes, in some implementations, a greater number of sets of paired first electrodes and second electrodes may be used. For example, when multiple first electrode and second electrode pairs are connected electrically in parallel, the variable circuit capacitance of the resulting varactor may be scaled proportionally.

In some implementations, the first electrode(s) and the second electrode(s) may both be connected to separate electrical terminals. The terminals may allow for electrical interconnects between the in-plane MEMS varactor and an external electrical circuit. In some implementations, one of the terminals may be at substantially the same electric potential as the first electrode and the other terminal at substantially the same electric potential as the second electrode. In some other implementations, the second electrode is allowed to float electrically at a potential between the potential at two separate first electrodes, each first electrode being connected to a corresponding terminal. In such implementations, the floating second electrode may be termed a “floating electrode” or a “shunt electrode.” In some implementations, the entire second portion of an in-plane MEMS varactor may serve as the second electrode (although, if a capacitive drive mechanism is also used, the fourth electrode(s) may need to be isolated from electrical conduction with the second portion, e.g., by an insulating layer).

It is to be understood that while the above discussion of electrodes and electrical routing has focused on implementations where the second portion moves while the first portion remains fixed with respect to the substrate, similar techniques may be used in implementations where the first portion moves while the second portion remains fixed with respect to the substrate, but altered to reflect the switched roles of the first electrode(s) and the second electrode(s). For example, in such implementations, the first electrode(s) may be electrically connected to a terminal or terminals by a conductive path traversing one or more of the beams linking the second portion to the first portion. Alternatively, the first electrode(s) may include a shunt electrode, and the second electrodes may include two terminals isolated from each other with respect to electrical conductivity.

It is to be further understood that while the discussion above has focused on implementations of the first electrode(s) and the second electrode(s), similar techniques may be used to implement the third electrode(s) and the fourth electrode(s) of a capacitive drive mechanism, were such a mechanism to be used. For example, an array of capacitive drive mechanisms may be provided in an in-plane varactor. When multiple third electrode and fourth electrode pairs act in parallel, the actuation force of the resulting actuation mechanism may be scaled proportionally.

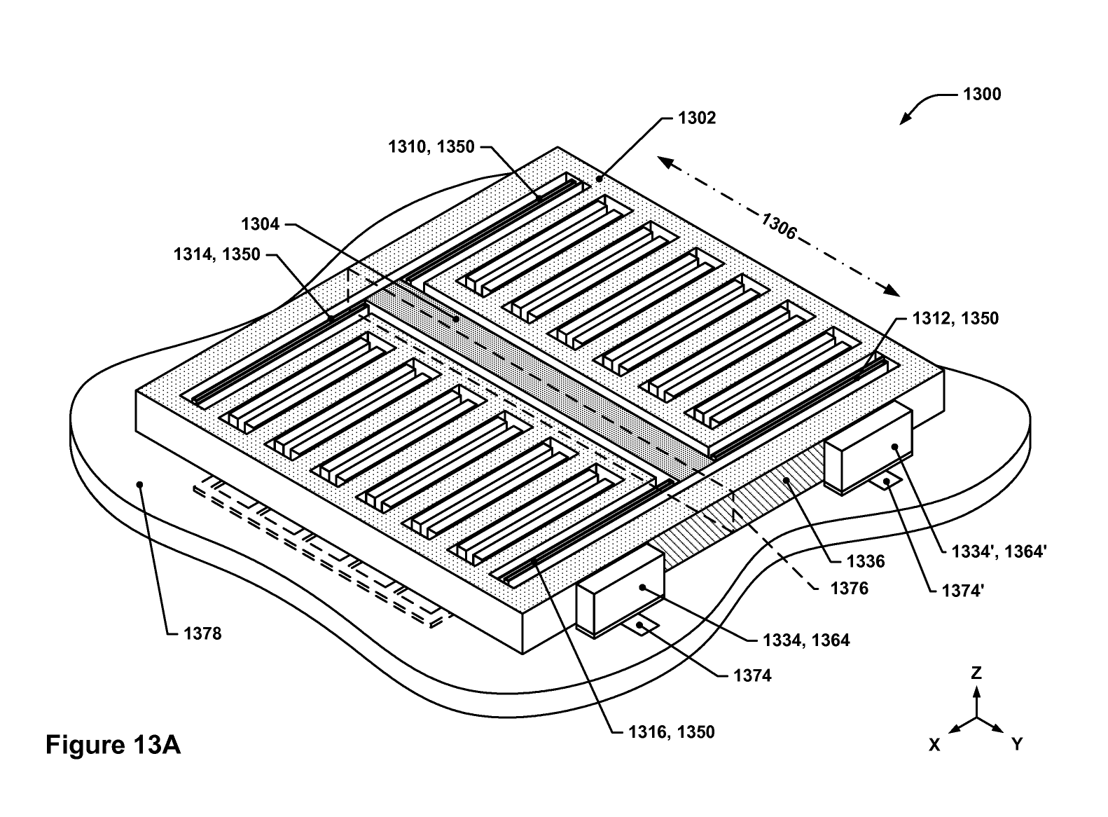

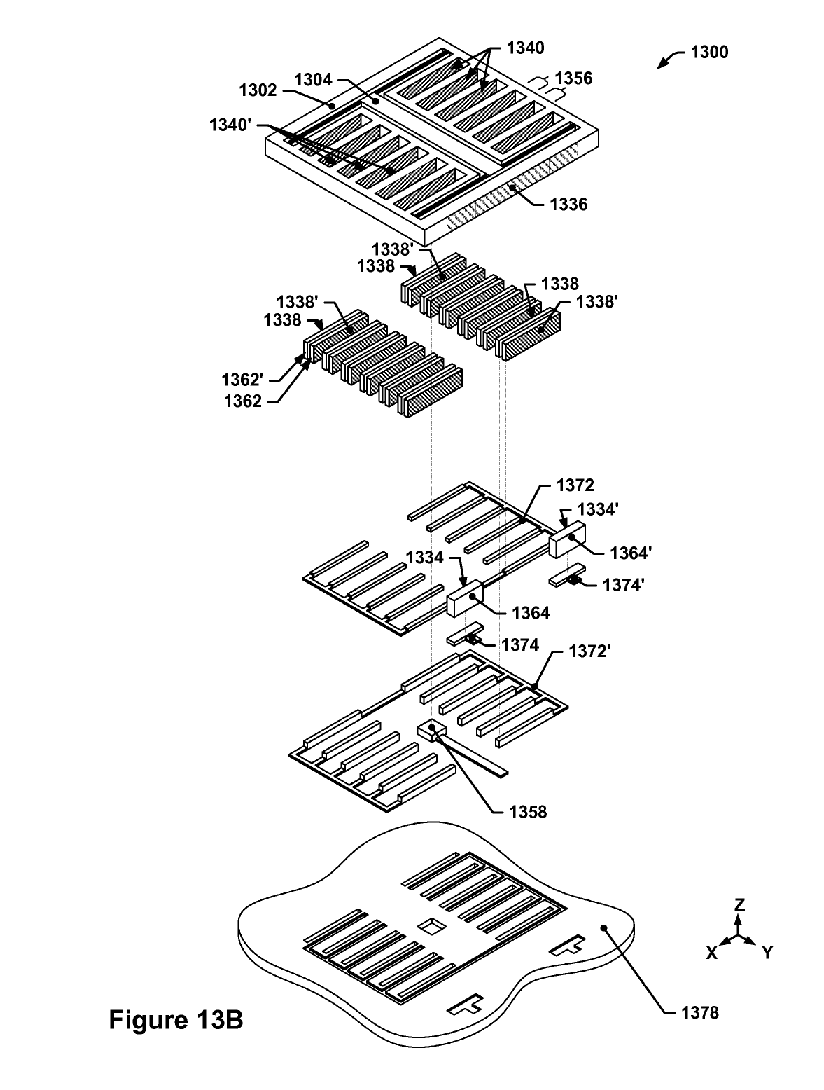

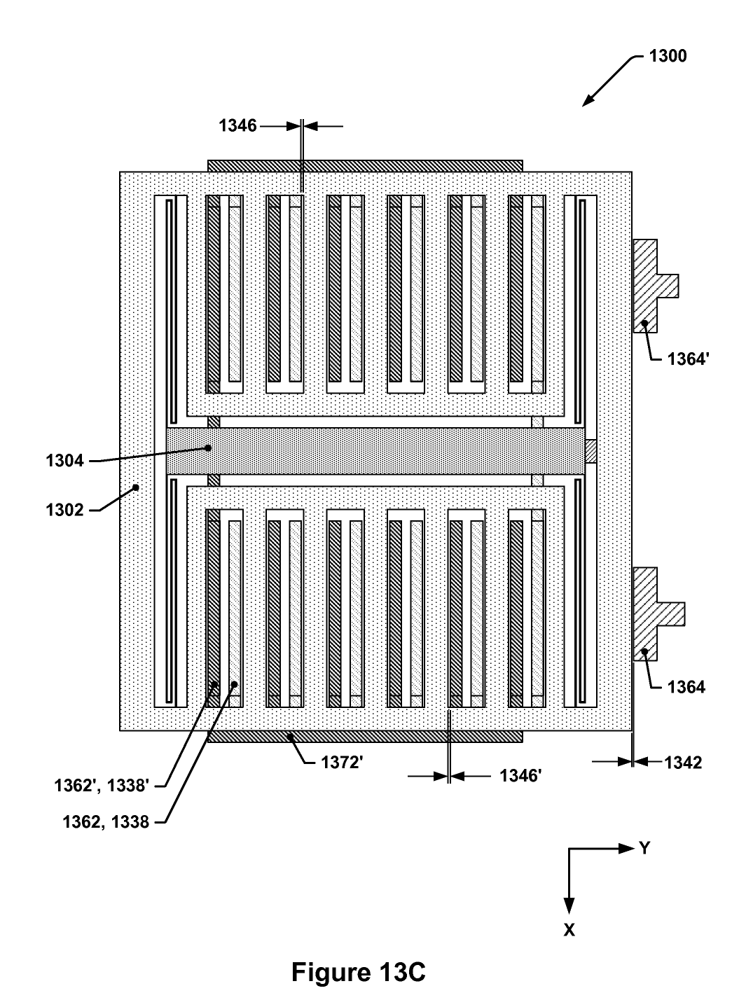

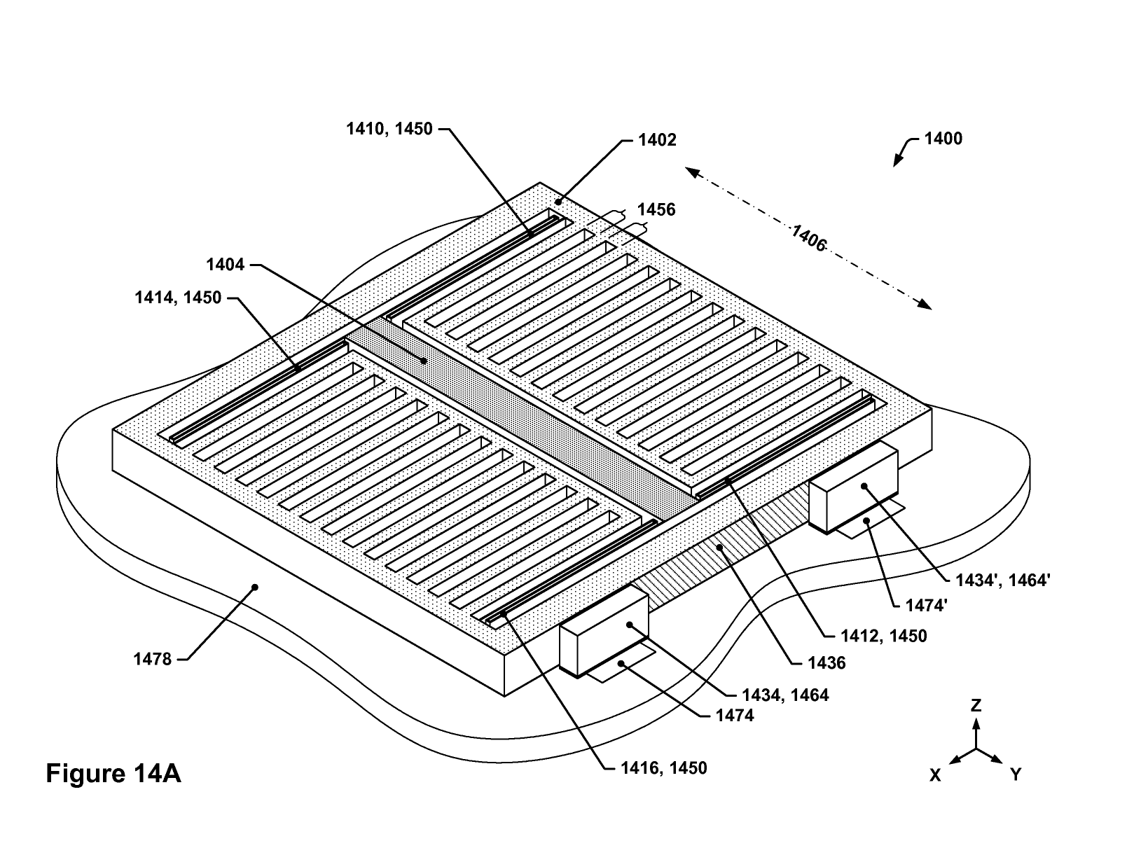

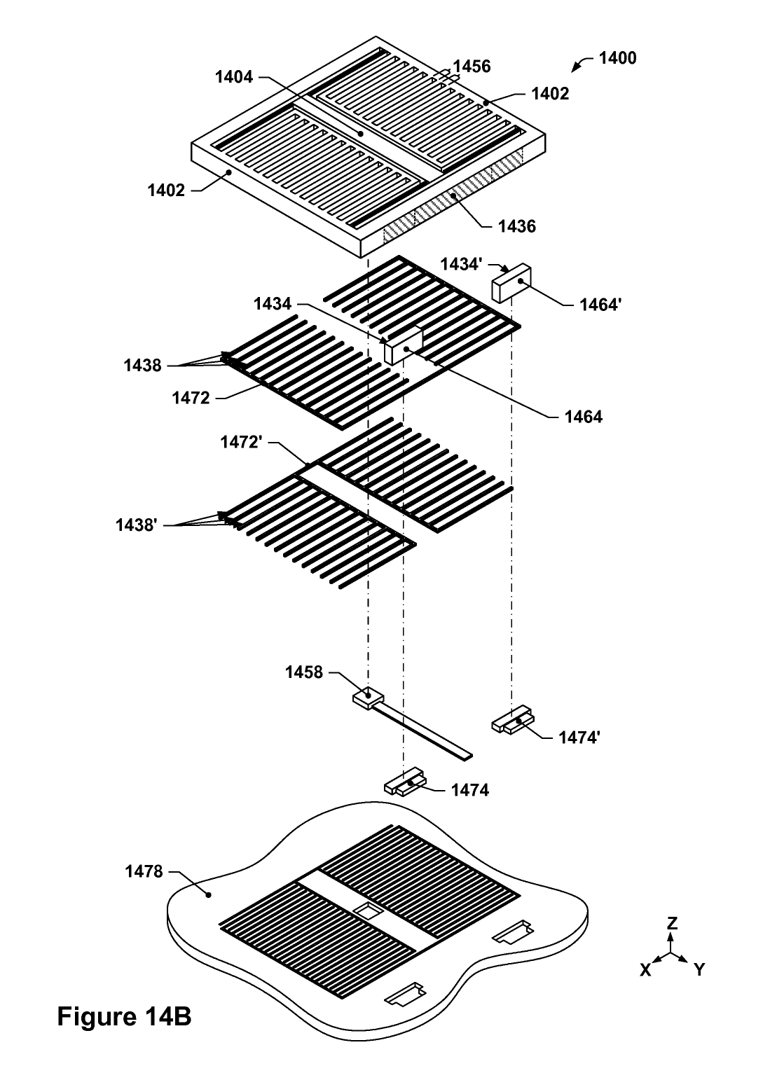

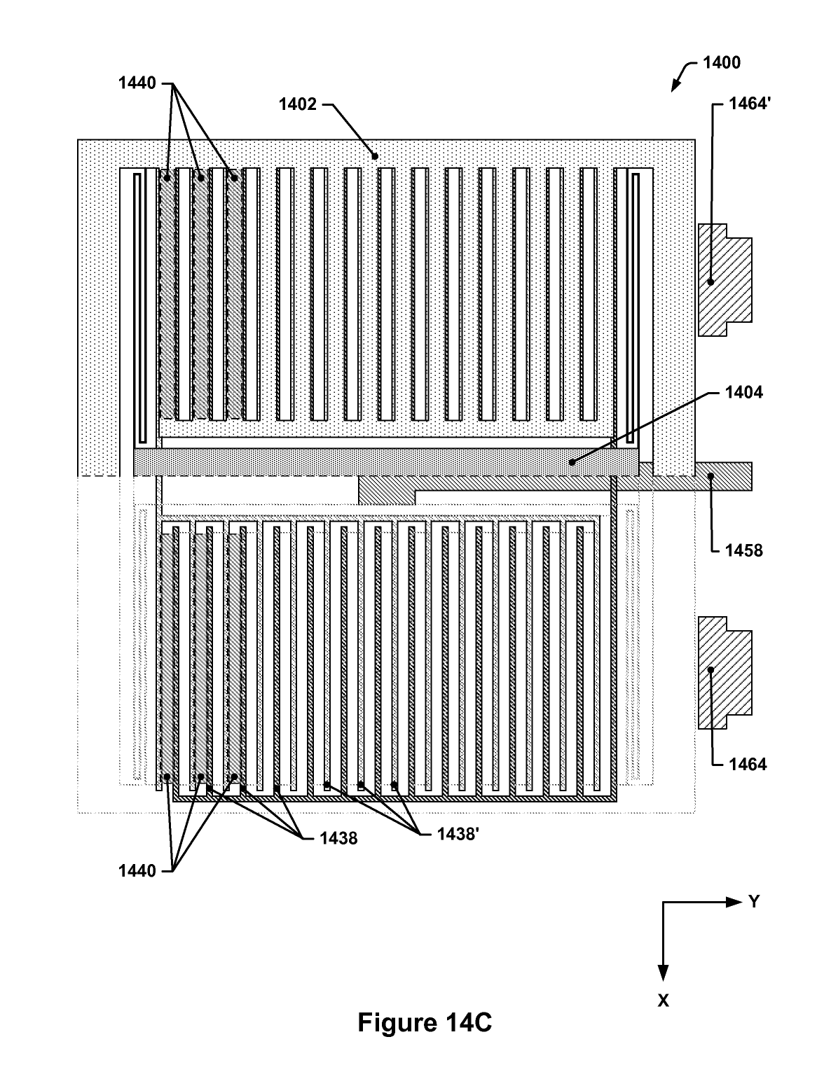

The above-discussed figures have considered various aspects of an in-plane MEMS varactor including, for example, implementations of beams to support one or two mechanically stable configurations, various implementations of a variable circuit capacitance mechanism, and various implementations of a capacitive actuation mechanism. FIGS. 13A through 14C, discussed below, depict select examples of implementations of an in-plane MEMS varactor including both an actuation mechanism and a variable circuit capacitance mechanism.

FIG. 13A depicts an isometric view of one example of an implementation of an in-plane MEMS varactor that uses a closing-gap capacitive mechanism with a shunt electrode to provide a variable circuit capacitance and a separate closing-gap capacitive actuation mechanism to impart translational motion. FIG. 13B depicts an isometric exploded view of the example of the implementation of the in-plane MEMS varactor of FIG. 13A. FIG. 13C depicts a plan view of the example of the implementation of the in-plane MEMS varactor of FIG. 13A.

An in-plane MEMS varactor 1300 may include a substrate 1378, a first portion 1304 that is fixed to the substrate 1378 by a central post 1358, and a second portion 1302 that is connected to a first portion 1304 by a first beam 1310, a second beam 1312, a third beam 1314, and a fourth beam 1316. In the depicted implementation, the second portion 1302, the first portion 1304, the first beam 1310, the second beam 1312, the third beam 1314, and the fourth beam 1316 may be formed as contiguous parts of a common MEMS structural layer and may, therefore, be substantially coplanar. The central post 1358 also may be used to route an electrical signal from the first portion 1304 to the substrate 1378. The substrate 1378 may be substantially parallel to the plane substantially containing the second portion 1302, the first portion 1304, the first beam 1310, the second beam 1312, the third beam 1314, and the fourth beam 1316. Also in the depicted implementation, the first portion 1304 may be seen in the plan view provided by FIG. 13C to be relatively small in plan area compared to the second portion 1302, and the second portion 1302 may be seen to surround the first portion 1304. The in-plane MEMS varactor 1300 may be substantially symmetric across symmetry plane 1376, although asymmetric implementations may be used as well.

The first beam 1310, the second beam 1312, the third beam 1314, and the fourth beam 1316 may be configured to allow relative motion between the first portion 1304 and the second portion 1302 by undergoing elastic deformation. The first beam 1310, the second beam 1312, the third beam 1314, and the fourth beam 1316 further may be configured to substantially constrain the relative motion between the first portion 1304 and the second portion 1302 to a single translational degree of freedom along a translation axis 1306. The first beam 1310, the second beam 1312, the third beam 1314, and the fourth beam 1316 are shown in this implementation to be folded beam elements 1350 that are similar to the beam 310′″ in FIG. 3C; however, other flexure types may be substituted.

In order to provide a variable circuit capacitance, the in-plane varactor 1300 further may further include capacitive electrode posts 1364 and 1364′ that are fixed with respect to the substrate 1378 and that face an electrically floating shunt electrode 1336. The shunt electrode 1336 may be supported by an exterior lateral surface of the second portion 1302 that is normal to the translation axis 1306. Each capacitive electrode post 1364 and 1364′ may support first electrodes 1334 and 1334′, respectively, on a lateral surface facing the shunt electrode 1336. Each of the capacitive electrode posts 1364 and 1364′ furthermore may be conductively connected to an electrical terminal 1374 and 1374′, respectively. Thus, the first electrode 1334 and the electrical terminal 1374 may be substantially at a first electrical potential, the first electrode 1334′ and the electrical terminal 1374′ may be substantially at a second electrical potential, and the shunt electrode 1336 may be at a third electrical potential substantially in between the first potential and the second potential.

The in-plane varactor 1300 may be configured to provide a variable circuit capacitance between the electrical terminals 1374 and 1374′. A variable circuit capacitance between the electrical terminals 1374 and 1374′ may be the series combination of a first capacitance between the first electrode 1334 and the shunt electrode 1336, and of a second capacitance between the first electrode 1334′ and the shunt electrode 1336. In some implementations the first capacitance and the second capacitance may be substantially equal and may vary as a function of the size of a capacitive gap 1342 between the first electrodes 1334 and 1334′ and the shunt electrode 1336. The size of the capacitive gap 1342 may be determined by the relative positions of the second portion 1302 and the first portion 1304, which may be varied using an actuation mechanism for an in-plane varactor. Thus, a variable circuit capacitance between the electrical terminals 1374 and 1374′ may be varied using an actuation mechanism for an in-plane varactor. If desired, a second variable circuit capacitance unit may be located on the opposite side of the varactor, although its behavior may be the reverse of the variable capacitance unit described above (such as it may be in a high-capacitance state when the other variable capacitance unit is in a low-capacitance state, and vice-versa).

In order to provide an actuation mechanism, the in-plane varactor 1300 may further include actuation electrode posts 1362 and 1362′ that are parallel to each other, fixed with respect to the substrate 1378, and that protrude into an opening 1356 in the second portion 1302. In some implementations, the opening 1356 may be an elongated slot. For example, the opening 1356 in FIGS. 13A through 13C may be an elongated rectangular (as seen in a plan view) slot with a shorter dimension that is parallel to the translation axis 1306 and a longer dimension that is perpendicular to the translation axis 1306. Although a slot is an example of an opening that is fully enclosed within the second portion 1302, the opening 1356 may not be fully enclosed in some implementations. Third electrodes 1338 and 1338′ may be located on opposite lateral surfaces the actuation electrode posts 1362 and 1362′, respectively. The third electrodes 1338 and 1338′ may, in turn, be electrically connected to actuation electrode routings 1372 and 1372′, respectively, that are fixed with respect to the substrate 1378. In some implementations, the actuation electrode routings 1372 and 1372′ may be conductively isolated from one another by an insulating dielectric layer (not shown in FIG. 13). In some implementations, the actuation electrode posts 1362 and 1362′ may be formed of a conductive material, in which case lateral surfaces of the actuation electrode posts 1362 and 1362′ may impart the functionality of the third electrodes 1338 and 1338′, respectively (i.e., actuation electrode posts 1362 and 1362′ and the third electrodes 1338 and 1338′ may be formed as monolithic structures).

Also visible in FIG. 13B are fourth electrodes 1340 and 1340′ that may be supported by lateral surfaces of the first portion 1304 facing the third electrodes 1338 and 1338′, respectively. The third electrodes 1338 and the fourth electrodes 1340 may be separated by a second gap 1346. Similarly, the third electrodes 1338′ and the fourth electrodes 1340′ may be separated by a second gap 1346′. The size of the second gaps 1346 and 1346′ may change when the second portion 1302 and the first portion 1304 undergo relative motion with respect to one another.

Applying a voltage difference between the third electrodes 1338′ and the fourth electrodes 1340′ produces a force across the second gap 1346′ that displaces the second portion 1302 in the positive y-direction towards the first portion 1304. The electrostatic force acting across the second gap 1346′ may be opposed by an elastic restoring force in the first beam 1310, the second beam 1312, the third beam 1314, and the fourth beam 1316. Static equilibrium configurations of the varactor 1300 may occur for configurations in which the net resultant force acting on the system is zero (i.e., when the electrostatic force and the elastic force are “equal and opposite”). In some implementations, it may be desirable to tie the third electrode 1338 to the same potential as the second portion 1302 when actuating the second portion 1302 in the positive y-direction.

Similarly, applying a voltage difference between the third electrodes 1338 and the fourth electrodes 1340 produces an electrostatic force across the second gap 1346 that displaces the second portion 1302 in the negative y-direction towards the first portion 1304. The electrostatic force acting across the second gap 1346 may be opposed by an elastic restoring force in the first beam 1310, the second beam 1312, the third beam 1314, and the fourth beam 1316. Static equilibrium configurations of the varactor 1300 may occur for configurations in which the net resultant force acting on the system is zero (i.e., when the electrostatic force and the elastic force are “equal and opposite”). In some implementations, it may be desirable to tie the third electrode 1338′ to the same potential as the second portion 1302 when actuating the second portion 1302 in the negative y-direction.

The second portion 1302 may support an arbitrary number of the openings 1356 and the fourth electrodes 1340 and 1340′, and the substrate 1378 may support a corresponding number of the actuation electrode posts 1362 and 1362′ and the third electrodes 1338 and 1338′. Taken together, each of the openings 1356 and the corresponding fourth electrodes 1340 and 1340′, the actuation electrode posts 1362 and 1362′, and the third electrodes 1338 and 1338′ may include a single unit cell of capacitive actuation. Thus, a closing-gap actuation mechanism for the in-plane MEMS varactor 1300 may include an arbitrary number of capacitive actuation unit cells in order to scale the effective actuation force that is available to impart relative motion between the second portion 1302 and the first portion 1304. The depicted closing-gap capacitive actuation mechanism is thus seen to be an example of a bidirectional actuation mechanism. In some implementations, the actuation mechanism may only be unidirectional and reverse actuation may be provided through the restorative force provided by the beams. Although the depicted closing-gap actuation mechanism for the in-plane MEMS varactor 1300 includes a two-by-six array of capacitive actuation unit cells, it is to be understood that other numbers of capacitive actuation unit cells alternatively may be arranged in 1-dimensional or 2-dimensional arrays or other patterns.

In some implementations, it may be desirable to form the second portion 1302 from an insulating material in order to impart electrical isolation between the fourth electrodes 1340 and 1340′ and the shunt electrode 1336. In some other implementations, the second portion 1302 may be formed from an electrically conductive material, in which case the shunt electrode 1336 may be conductively isolated from the second portion 1302 by means of an insulating layer such as a sidewall dielectric (not shown).

In some implementations, the rate at which the capacitance between the first electrodes 1334 and 1334′ and the shunt electrodes 1336 changes may be substantially smaller than the rate at which the capacitance between the third electrodes 1338 and 1338′ and the fourth electrodes 1340 and 1340′ changes with respect to relative displacement of the second portion 1302 and the first portion 1304 along the translational axis 1306. Accordingly, the electrostatic force acting between the first electrodes 1334 and 1334′ and the shunt electrodes 1336 may be substantially smaller than the electrostatic force acting between the third electrodes 1338 and 1338′ and the fourth electrodes 1340 and 1340′. The in-plane MEMS varactor 1300 may thereby be better able to resist “self-actuation”, or the tendency for the variable circuit capacitance to cause undesired actuation between the second portion 1302 and the first portion 1304. Bidirectional actuation may further increase the ability of the in-plane varactor 1300 to resist self-actuation.

Implementations of an in-plane varactor using electrically floating shunt electrodes that are fixed with respect to a movable portion of the varactor may obviate the need to route conductive traces between the movable portion of the varactor and a non-moving portion of the varactor (i.e., those portions that are fixed with respect to a substrate). This feature may simplify the design and manufacturing process of such an in-plane varactor.

FIG. 14A depicts an isometric view of an example of an implementation of an in-plane MEMS varactor that uses a closing-gap capacitive mechanism to provide a variable circuit capacitance and a separate changing-overlap capacitive actuation mechanism to impart translational motion. FIG. 14B depicts an isometric exploded view of the example of the implementation of the in-plane MEMS varactor of FIG. 14A. FIG. 14C depicts a plan view of the example of the implementation of the in-plane MEMS varactor of FIG. 14A.

As can be seen, many of the components of in-plane MEMS varactor 1400 shown in FIGS. 14A through 14C are similar to those used in the in-plane MEMS varactor 1300 shown in FIGS. 13A through 13C. For example, the in-plane MEMS varactors 1300 and 1400 both use substantially the same implementation of a closing-gap capacitance mechanism to provide a variable circuit capacitance output. Accordingly, the in-plane MEMS varactor 1400 features first electrodes 1434 and 1434′, shunt electrode 1436, capacitive electrode posts 1464 and 1464′, and electrical terminals 1474 and 1474′ that are similar in topology and function to the corresponding structures in FIGS. 13A through 13C.

As further examples of similarities to the in-plane MEMS varactor 1300, the in-plane MEMS varactor 1400 also may include a first portion 1404 that is fixed to a substrate 1478 by a central post 1458 and a second portion 1402 that is connected to a first portion 1404 by a first beam 1410, a second beam 1412, a third beam 1414, and a fourth beam 1416. The first beam 1410, the second beam 1412, the third beam 1414, and the fourth beam 1416 also may include folded beam elements 1450. The first beam 1410, the second beam 1412, the third beam 1414, and the fourth beam 1416 may substantially constrain relative motion between the second portion 1402 and the first portion 1404 to a single degree of freedom along a translation axis 1406. The first beam 1410, the second beam 1412, the third beam 1414, and the fourth beam 1416 are shown in this implementation to be folded beam elements 1450 similar to the beam 310′″ in FIG. 3C; however, other flexure types may be substituted. In some implementations, the second portion 1402 may contain one or more openings 1456; the second portion 1402 shown in FIGS. 14A through 14C includes 26 openings 1456 arranged in a two-by-thirteen array.

The depicted implementations of the in-plane MEMS varactors 1400 and 1300, however, employ different capacitive actuation mechanisms: the in-plane varactor 1400 uses a changing-overlap capacitive actuation mechanism whereas the in-plane varactor 1300 uses a closing-gap capacitive actuation mechanism. The use of different actuation mechanisms may result in differences, in terms of topology, function, or both, in the structures providing the actuation mechanisms of the in-plane MEMS varactors 1300 and 1400. However, the structures providing the actuation mechanisms of the in-plane MEMS varactor 1400 do share similarities in terms of topology and function to corresponding structures in FIG. 12A through 12C, which depict another example of a changing-overlap capacitive actuation mechanism. Accordingly, the in-plane MEMS varactor 1400 further may include third electrodes 1438 and 1438′, and actuation electrode routing 1472 and 1472′. In some implementations, the third electrodes 1438 and 1438′ may be fixed with respect to the substrate 1478 and arranged substantially parallel to a bottom surface of the second portion 1402 facing opposite edges of the openings 1456. Although present in the depicted implementation, the openings 1456 may not be necessary in some other implementations in which the second portion 1402 is formed from an insulating material.

The actuation electrode routing 1472 also may be fixed with respect to the substrate 1478 and further may be electrically connected to a third electrode 1438. Similarly, the actuation electrode routing 1472′ also may be fixed with respect to the substrate 1478 and further may be electrically connected to a third electrode 1438′. In the depicted implementation of the in-plane MEMS varactor 1400, the third electrodes 1438 and 1438′ may be interleaved as shown in FIG. 14C. In some implementations, the actuation electrode routing 1472 and 1472′ may be conductively isolated from one another by an insulating dielectric layer (not shown in FIG. 14).

Also included in the in-plane varactor 1400, although not visible in FIGS. 14A through 14C, are fourth electrodes 1440 that may be fixed with respect to a bottom surface of the second portion 1402 and that may occupy an area adjacent to the openings 1456 and facing the third electrodes 1438 and 1438′. In some implementations, the fourth electrodes 1440 may be conductively connected with the central post 1458 to provide electrical routing to the substrate 1478.

Applying a voltage difference between the third electrodes 1438 and the fourth electrodes 1440 causes an electrostatic force that displaces the second portion 1402 in the positive y-direction towards the first portion 1404, thereby increasing the amount of overlap between the third electrodes 1438 and the fourth electrodes 1440. The electrostatic force acting between the third electrodes 1438 and the fourth electrodes 1440 may be opposed by an elastic restoring force in the first beam 1410, the second beam 1412, the third beam 1414, and the fourth beam 1416. Static equilibrium configurations of the in-plane varactor 1400 may occur for configurations in which the net resultant force acting on the system is zero (i.e., when the electrostatic force and the elastic force are “equal and opposite”). In some implementations, it may be desirable to tie the third electrodes 1438′ to the same potential as the second portion 1402 when actuating the second portion 1402 in the positive y-direction.

Similarly, applying a voltage difference between the third electrodes 1438′ and the fourth electrodes 1440 causes an electrostatic force that displaces the second portion 1402 in the negative y-direction towards the first portion 1404, thereby increasing the amount of overlap between the third electrodes 1438′ and the fourth electrodes 1440. The electrostatic force acting between the third electrodes 1438′ and the fourth electrodes 1440 may be opposed by an elastic restoring force in the first beam 1410, the second beam 1412, the third beam 1414, and the fourth beam 1416. Static equilibrium configurations of the in-plane varactor 1400 may occur for configurations in which the net resultant force acting on the system is zero (i.e., when the electrostatic force and the elastic force are “equal and opposite”). In some implementations, it may be desirable to tie the third electrodes 1438 to the same potential as the second portion 1402 when actuating the second portion 1402 in the negative y-direction.

The second portion 1402 may support an arbitrary number of the openings 1456 and the fourth electrodes 1440, and the substrate 1478 may support a corresponding number of the third electrodes 1438 and 1438′. Taken together, each of the openings 1456 and the corresponding fourth electrodes 1440 and third electrodes 1438 and 1438′ may include a single unit cell of capacitive actuation. Thus, a changing-overlap actuation mechanism for the in-plane MEMS varactor 1400 may include an arbitrary number of capacitive actuation unit cells in order to scale the effective actuation force that is available to impart relative motion between the second portion 1402 and the first portion 1404. The depicted changing-overlap capacitive actuation mechanism is thus seen to be an example of a bidirectional actuation mechanism. Although the depicted changing-overlap actuation mechanism for the in-plane MEMS varactor 1400 features a two-by-thirteen array of capacitive actuation unit cells, it is to be understood that other numbers of capacitive actuation unit cells alternatively may be arranged in 1-dimensional or 2-dimensional arrays or other patterns.

In some implementations, it may be desirable to form the second portion 1402 from an insulating material in order to impart electrical isolation between the fourth electrodes 1440 and the shunt electrode 1436. In some other implementations, the second portion 1402 may be formed from an electrically conductive material, in which case the shunt electrode 1436 may be conductively isolated from the second portion 1402 by means of an insulating layer such as a sidewall dielectric (not shown).

In some implementations, the rate at which the capacitance between the first electrodes 1434 and 1434′ and the shunt electrode 1436 changes may be substantially smaller than the rate at which the capacitance between the third electrodes 1438 and 1438′ and the fourth electrodes 1440 changes with respect to relative displacement of the second portion 1402 and the first portion 1404 along the translational axis 1406. Accordingly, the electrostatic force acting between the first electrodes 1434 and 1434′ and the shunt electrode 1436 may be substantially smaller than the electrostatic force acting between the third electrodes 1438 and 1438′ and the fourth electrodes 1440. The in-plane varactor 1400 may thereby be better able to resist self-actuation, or the tendency for the variable circuit capacitance to cause undesired actuation between the second portion 1402 and the first portion 1404. Bidirectional actuation may further increase the ability of the in-plane varactor 1400 to resist self-actuation.

FIG. 14C depicts a plan view of the in-plane MEMS varactor 1400 in its mechanically stable state. In the mechanically stable state, opposing edges of the fourth electrodes 1440 may each be substantially centered with respect to the corresponding third electrodes 1438 and 1438′. The outlines of some of the fourth electrodes are indicated by dashed lines in the upper half of FIG. 14C for clarity. Also, the second portion 1402 and the first portion 1404 indicated by grey dotted lines in the lower half of FIG. 14C to reveal the third electrodes 1438 and 1438′ underneath. As can be seen, the third electrodes 1438 and 1438′ may only partially overlap the fourth electrodes 1440, which are not visible on the bottom surface of the second portion 1402 between the openings 1456 (although, as noted above, some of the fourth electrodes 1440 are indicated using dashed lines for clarity), when the in-plane varactor 1400 is in the depicted mechanically stable configuration.

It is to be understood that while the examples of implementations of in-plane MEMS varactors 1300 and 1400 both use folded beam elements, beams such as those depicted in FIG. 3B may be used instead to produce an in-plane MEMS varactor 1300 or 1400 that is mechanically bi-stable. A person having ordinary skill in the art will readily understand that in some implementations, a bi-directional actuation mechanism may be preferred to actuate a mechanically bi-stable in-plane MEMS varactor. Additionally, a unidirectional actuation mechanism may be preferred to actuate an in-plane MEMS varactor having a single mechanically stable configuration, in which case the elastic restoring force in the beams imparts an actuation effort in the direction opposing the actuation direction of the actuation mechanism.

The implementations depicted in FIGS. 13A to 14C are merely representative examples of possible combinations of variable circuit capacitance mechanisms, actuation mechanisms, and their constituent structures that may be used to realize an in-plane MEMS varactor. Implementations of an in-plane MEMS varactor including any other appropriate combinations of the above elements are understood to fall within the scope of this disclosure.

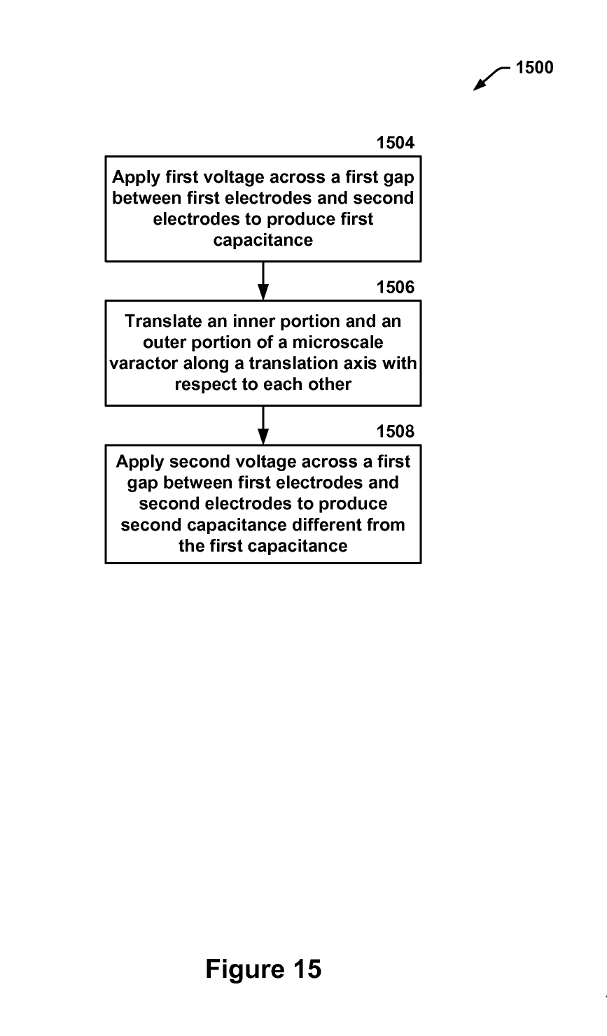

FIG. 15 depicts a block diagram showing one example of a technique for using an in-plane MEMS varactor. In block 1504, a voltage may be applied across a first gap between a first electrode and a second electrode of an in-plane MEMS varactor, such as those discussed above with respect to the preceding Figures. A first capacitance may be produced across the first gap.

In block 1506, the second portion and the first portion of the in-plane MEMS varactor may undergo relative translation along a translation axis. This translation may cause the first gap to change, or may cause the amount of overlap between the first and second electrodes to change, thus producing a change in capacitance. The translation axis may be substantially parallel to the substrate supporting the in-plane MEMS varactor, the second portion and the first portion may be substantially co-planar with each other, the first electrode may be fixed with respect to the first portion, and the second electrode may be fixed with respect to the second portion.

In block 1508, a second voltage may be applied across the first gap between the first electrode and the second electrode of the in-plane MEMS varactor. A second capacitance may be produced across the first gap. The second capacitance may be different than the first capacitance as a result of the movement of the second portion and the first portion with respect to each other.

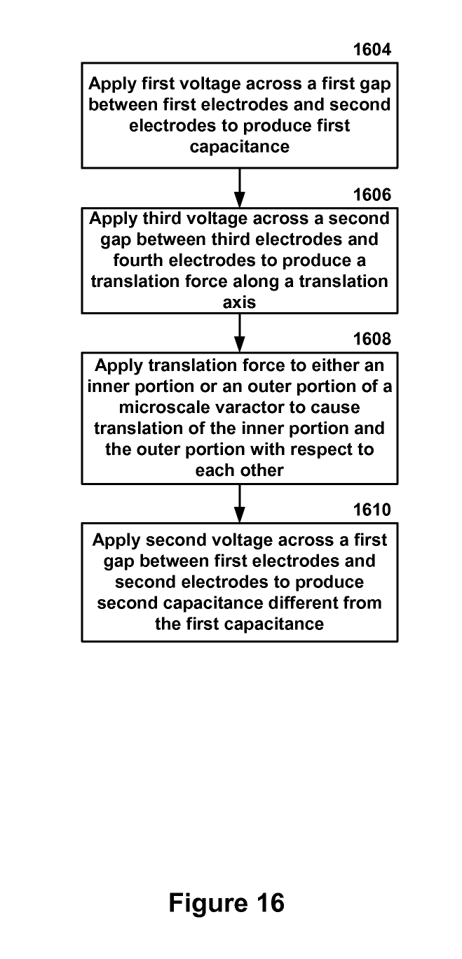

FIG. 16 depicts a block diagram showing a further example of a technique for using an in-plane MEMS varactor. In block 1604, a voltage may be applied across a first gap between a first electrode and a second electrode of an in-plane MEMS varactor, such as those discussed above with respect to the preceding Figures. A first capacitance may be produced across the first gap.

In block 1606, a third voltage may be applied across a second gap between a third electrode and a fourth electrode, such as those discussed above with respect to various preceding Figures. This may produce a force along a translation axis generally parallel to the in-plane MEMS varactor substrate.

In block 1608, the force may be applied to either the second portion or the first portion of the in-plane MEMS varactor in order to produce relative translational motion between the second portion and the first portion. This translation may cause the first gap to change, or may cause the amount of overlap between the first and second electrodes to change, thus producing a change in capacitance across the first gap. The second portion and the first portion may be substantially co-planar with each other, the first electrode may be fixed with respect to the first portion, and the second electrode may be fixed with respect to the second portion.

In block 1610, a second voltage may be applied across the first gap between the first electrode and the second electrode of the in-plane MEMS varactor. A second capacitance may be produced across the first gap. The second capacitance may be different than the first capacitance as a result of the movement of the second portion and the first portion with respect to each other.

It is to be understood that the above techniques may be practiced with multiple first electrodes, second electrodes, etc. As referenced previously, various MEMS-process compatible materials may be used to fabricate an in-plane MEMS varactor. As a result various elements of an in-plane MEMS varactor may be made from different materials. The first electrode(s), second electrode(s), and, if used, the third electrode(s) and the fourth electrode(s), may be made from conductive materials, as may any routing or traces electrically connected with these elements. The second portion and first portion, as well as the beams, may be made from a non-conductive material (such as polymers, ceramics, glass, etc.). In some implementations, the second portion or the first portion may themselves act as electrodes, and may be made from a conductive material. In such implementations, however, a layer insulating material may be desirable in the second portion or the first portion to mitigate undesired electrical coupling between the main body of the second portion or the first portion and any electrodes that must be kept electrically isolated from the second portion or the first portion. Various sacrificial layer materials may be used during manufacturing to temporarily support various parts during production. Such sacrificial layers may then be removed using an appropriate technique (such as a chemical etch process) to allow relative movement between the second portion and the first portion.

A person having ordinary skill in the art will readily understand that the above techniques may be practiced with multiple first electrodes, second electrodes, etc. Additionally, while reference is made throughout this application to “MEMS” devices, similar structures and techniques, after appropriate scaling, also may be implemented at a nanoelectromechanical system (“NEMS”) scale, at a meso-scale, or at a macro-scale as well.

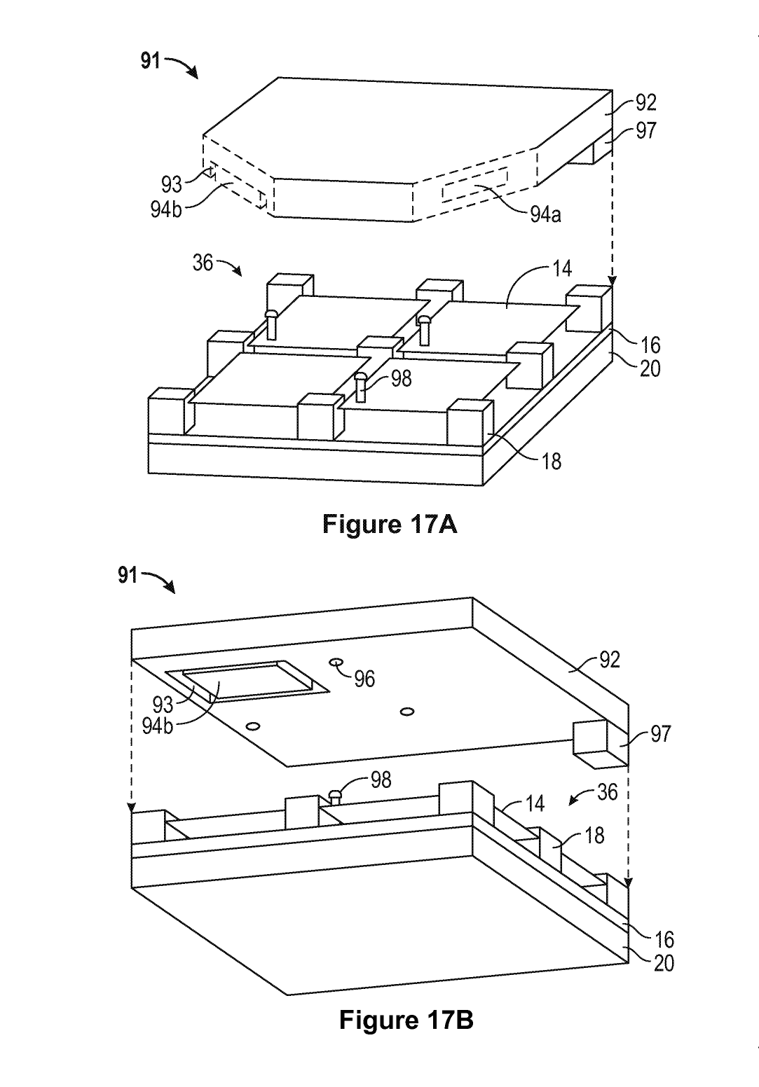

FIGS. 17A and 17B depict example schematic exploded partial perspective views of a portion of an EMS package 91 including an array 36 of EMS elements and a backplate 92. FIG. 17A is shown with two corners of the backplate 92 cut away to better illustrate certain portions of the backplate 92, while FIG. 17B is shown without the corners cut away. The EMS array 36 can include a substrate 20, support posts 18, and a movable layer 14. In some implementations, the EMS array 36 can include an array of interferometric modulator (IMOD) display elements with one or more optical stack portions 16 on a transparent substrate, and the movable layer 14 can be implemented as a movable reflective layer.

The backplate 92 can be essentially planar or can have at least one contoured surface (e.g., the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 17A and 17B, the backplate 92 can include one or more backplate components 94a and 94b, that can be partially or wholly embedded in the backplate 92. As can be seen in FIG. 17A, backplate component 94a is embedded in the backplate 92. As can be seen in FIGS. 17A and 17B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, varactors, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 17B includes one or more conductive vias 96 on the backplate 92 that can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants that act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 17A and 17B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 17A and 17B, a seal can be provided that partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

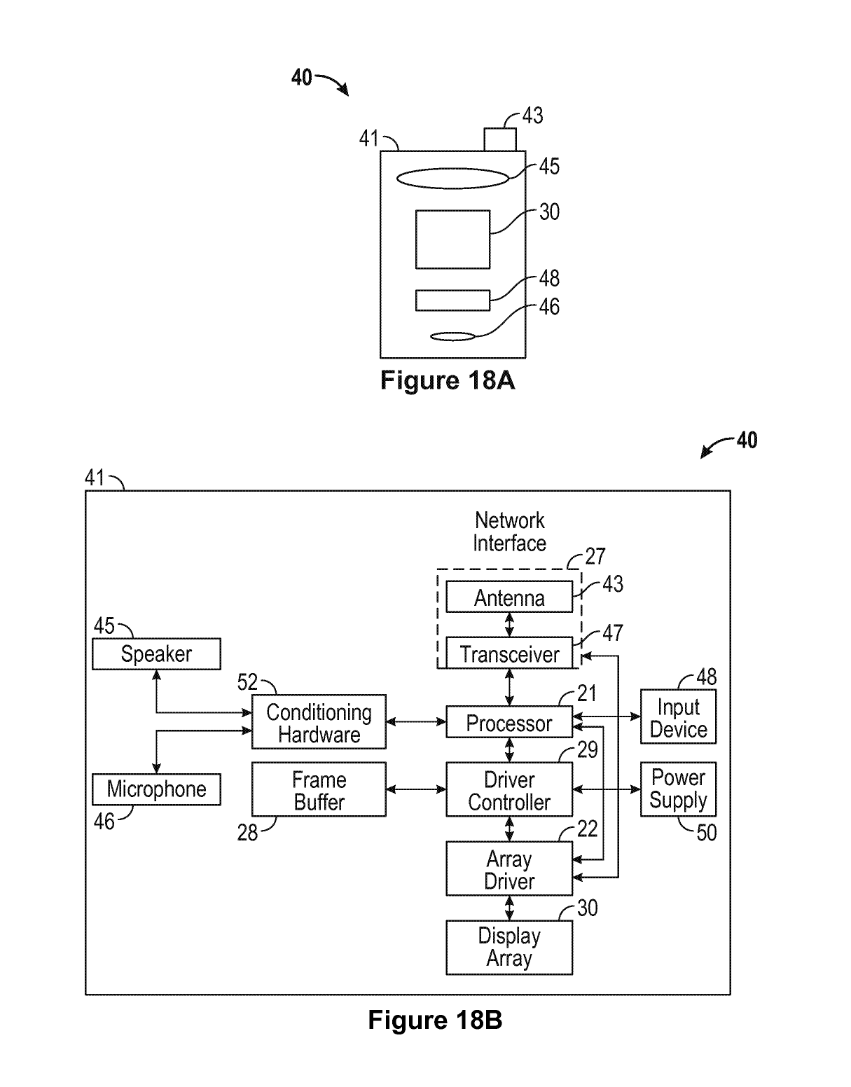

FIGS. 18A and 18B depict example system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 18A. The display device 40 includes a housing 41 and can include additional components at least partially enclosed therein. For example, the display device 40 includes a network interface 27 that includes an antenna 43 that can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal, e.g., by using a circuit including an in-plane MEMS varactor). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 18A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for both conventional LCD and AMOLED displays and for interferometric MEMS displays, such as IMOD displays. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 that can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A varactor comprising:
a substrate;
a first portion in a plane substantially parallel to the substrate;
a second portion substantially co-planar with the first portion;
one or more first electrodes substantially fixed with respect to the first portion;
one or more second electrodes substantially fixed with respect to the second portion;
a first beam joined to the second portion at a first end of the first beam and joined to the first portion at a second end of the first beam opposite the first end of the first beam, the first beam substantially co-planar with the second portion and the first portion;
a second beam joined to the second portion at a first end of the second beam and joined to the first portion at a second end of the second beam opposite the first end of the second beam, the second beam substantially co-planar with the second portion and the first portion; and
a drive mechanism, wherein:
the first beam and the second beam are elastic elements that are free to deform substantially by bending in a plane parallel to the substrate,
the first beam and the second beam are configured to constrain relative motion between the second portion and first portion to a single translational degree of freedom substantially along a translation axis parallel to the substrate,
the one or more first electrodes are configured to undergo substantially the same translational motion as the first portion,
the one or more second electrodes are configured to undergo substantially the same translational motion as the second portion,
relative linear translation of the first portion with respect to the second portion results in a change in capacitance associated with the one or more first electrodes and the one or more second electrodes, and
the drive mechanism is configured to cause relative linear translation between the first portion and the second portion.

2. The varactor of claim 1, wherein the drive mechanism is a capacitive drive mechanism that is conductively isolated from the one or more first electrodes and the one or more second electrodes.

3. The varactor of claim 2, wherein the capacitive drive mechanism is selected from the group consisting of a closing-gap capacitive drive mechanism and a changing-overlap capacitive drive mechanism.

4. The varactor of claim 2, wherein the capacitive drive mechanism includes one or more third electrodes and one or more fourth electrodes, the one or more third electrodes substantially fixed with respect to the first portion, the one or more fourth electrodes substantially fixed with respect to the second portion, and wherein:
the one or more first electrodes and the one or more second electrodes are separated by a first gap and overlap each other in a first overlap area,
the one or more third electrodes and the one or more fourth electrodes are separated by a second gap and overlap each other in a second overlap area, and
the first overlap area divided by the first gap is substantially less than the second overlap area divided by the second gap.

5. The varactor of claim 4, further comprising:
a third beam joined to the second portion at a third end of the third beam and joined to the first portion at a fourth end of the third beam opposite the third end of the third beam, the third beam substantially co-planar with the second portion and the first portion; and
a fourth beam joined to the second portion at a third end of the fourth beam and joined to the first portion at a fourth end of the fourth beam opposite the third end of the fourth beam, the fourth beam substantially co-planar with the second portion and the first portion, wherein:
the third beam and the fourth beam are symmetric with respect to the first beam and the second beam, respectively, across a symmetry plane parallel to the translation axis and perpendicular to the substrate,
the first beam is offset from the third beam along the translation axis,
the second beam is offset from the fourth beam along the translation axis,
the second portion has a series of openings through one or more sub-portions of the second portion, wherein the one or more fourth electrodes are located on sides of the openings perpendicular to the translation axis, and
the first portion includes a central post fixed with respect to the substrate.

6. The varactor of claim 5, wherein the openings are at least two series of elongated slots in opposing sub-portions of the second portion, each slot having a substantially rectangular cross-section in a reference plane parallel to the substrate with a long axis in a direction transverse to the translation axis.

7. The varactor of claim 6, wherein:
the one or more third electrodes are located on at least two series of electrode posts fixed with respect to the substrate, each elongated slot having at least one drive electrode post protruding into it, wherein the one or more third electrodes are located on sides of the one or more drive electrode posts perpendicular to the translation axis.

8. The varactor of claim 5, wherein:
the one or more fourth electrodes are located on one or more regions of a surface of the second portion facing the substrate and interposed between the openings,
the one or more third electrodes are located on the substrate and facing the one or more fourth electrodes, and
the one or more third electrodes are spaced apart along the translation axis by distances corresponding to the spacing of the openings along the translation axis.

9. The varactor of claim 1, wherein the drive mechanism is a piezoelectric linear or bending actuator conductively isolated from the one or more first electrodes and the one or more second electrodes.

10. The varactor of claim 1, wherein the first beam and the second beam are folded beam elements.

11. The varactor of claim 1, further comprising:
a third beam joined to the second portion at a first end of the third beam and joined to the first portion at a second end of the third beam opposite the first end of the third beam and substantially co-planar with the second portion and the first portion; and
a fourth beam joined to the second portion at a first end of the fourth beam and joined to the first portion at a second end of the fourth beam opposite the first end of the fourth beam and substantially co-planar with the second portion and the first portion, wherein:
the first beam, the second beam, the third beam, and the fourth beam are all curved beams, each with a shape that substantially corresponds with approximately half of the shape of the first buckling mode of a straight, prismatic beam,
the third beam and the fourth beam are symmetric with respect to the first beam and the second beam, respectively, across a symmetry plane parallel to the translation axis and perpendicular to the substrate,
the first beam is offset from the third beam along the translation axis,
the second beam is offset from the fourth beam along the translation axis,
the first beam is substantially parallel to the third beam,
the second beam is substantially parallel to the fourth beam,
the first portion and the second portion are movable between a first configuration and a second configuration relative to each other,
in the first configuration, the first beam and the third beam are in an unstressed state,
in the second configuration, the first beam and the third beam are in a stressed state, and
the first portion and the second portion are configured to remain in the first configuration or the second configuration absent the application of an external force.

12. The varactor of claim 11, wherein the first configuration and the second configuration represent elastically stable states of the varactor.

13. The varactor of claim 12, wherein the varactor has two discrete capacitance states, each associated with a different one of the first configuration and the second configuration.

14. The varactor of claim 1, wherein the one or more first electrodes are separated from the one or more second electrodes by a gap distance along the linear translation axis that varies when the first portion and the second portion are linearly translated with respect to each other.

15. The varactor of claim 14, wherein:
the one or more first electrodes include a first subgroup of first electrodes and a second subgroup of first electrodes,
the first subgroup of first electrodes and the second subgroup of first electrodes are isolated from one another with respect to electrical conductivity, and
each of the one or more second electrodes is a floating shunt electrode that overlaps at least one of the first electrodes in the first subgroup of first electrodes and one of the first electrodes in the second subgroup of first electrodes during linear translation of the first portion with respect to the second portion along the linear translation axis.

16. The varactor of claim 1, wherein:
the one or more first electrodes are separated from the one or more second electrodes by a gap that remains substantially constant during linear translation of the first portion relative to the second portion, the gap in a direction substantially perpendicular to the plane,
the one or more first electrodes are configured to at least partially overlap the one or more second electrodes during at least some portion of linear translation of the first portion with respect to the second portion along the linear translation axis, and
the extent of the overlap between the one or more first electrodes and the one or more second electrodes varies when the first portion and the second portion are linearly translated with respect to each other.

17. The varactor of claim 16, wherein:
the one or more first electrodes include a first subgroup of first electrodes and a second subgroup of first electrodes,
the first subgroup of first electrodes and the second subgroup of first electrodes are isolated from one another with respect to electrical conductivity,
each of the one or more second electrodes is a floating shunt electrode that at least partially overlaps at least one of the first electrodes in the first subgroup of first electrodes and one of the first electrodes in the second subgroup of first electrodes during at least some portion of linear translation of the first portion with respect to the second portion along the linear translation axis, and
the extent of the overlap between each of the one or more second electrodes and the at least one of the first electrodes in the first subgroup of first electrodes and the at least one of the first electrodes in the second subgroup of first electrodes varies when the first portion and the second portion are linearly translated with respect to each other.

18. The varactor of claim 1, wherein the first portion is affixed to the substrate and the second portion is movable with respect to the substrate.

19. An apparatus comprising the varactor of claim 1, further comprising:
an inductor, wherein the varactor and the inductor are electrically connected in parallel or in series with one another to form an LC circuit.

20. The apparatus of claim 19, wherein the LC circuit is part of a radio-frequency (RF) component in a wireless mobile communications device.

21. The apparatus of claim 19, wherein the LC circuit is configured to be switchable between a first resonant frequency and a second resonant frequency by translating the first portion and the second portion of the varactor with respect to each other.

22. The apparatus of claim 19, wherein the LC circuit is part of at least one of a receiver, transceiver, and transmitter.

23. A varactor comprising:
stationary electrodes;
movable electrodes;
flexure means, the flexure means joining the stationary electrodes to the movable electrodes and constraining motion of the movable electrodes with respect to the stationary electrodes to be in-plane with the stationary electrodes; and
drive mechanism means configured for moving the movable electrodes with respect to the stationary electrodes between two positions, wherein the varactor provides different capacitances in each position.

24. The varactor of claim 23, wherein the flexure means has two elastically stable states, each associated with a different one of the two positions.

25. The varactor of claim 23, wherein the flexure means include two pairs of curved beams, each with a shape that substantially corresponds with approximately half of the shape of the first buckling mode of a straight, prismatic beam.

26. The varactor of claim 23, wherein the stationary electrodes and the movable electrodes are electrically isolated from the drive mechanism means with respect to electrical conductivity.

27. A method of using a varactor comprising:
applying a first voltage across a first gap between one or more first electrodes and one or more second electrodes to provide a first capacitance;
translating a second portion of the varactor with respect to a first portion of the varactor along a translation axis, wherein:
the translation axis is substantially parallel to a substrate of the varactor,
the second portion and the first portion are substantially co-planar with each other,
the one or more first electrodes are substantially fixed with respect to the first portion, and
the one or more second electrodes are substantially fixed with respect to the second portion; and
applying a voltage across the first gap to provide a second capacitance different from the first capacitance.

28. The method of claim 27, wherein the translating is performed by applying a voltage across a second gap between one or more third electrodes and one or more fourth electrodes to produce a first translation force, the first translation force acting on the second portion and the first portion and the one or more third electrodes and the one or more fourth electrodes isolated from the one or more first electrodes and the one or more second electrodes with respect to electrical conductivity.
